(19) United States
(12) Patent Application Publication
(10) Pub. No.: US 2002/0073740 A1
(43) Pub. Date: Jun. 20, 2002

(54) Fluorine doping a soot preform

(76) Inventors: Steven B. Dawes, Corning, NY (US); Andrew P. Schermerhorn, Corning, NY (US); V. Srikant, Ithaca, NY (US); Pushkar Tandon, Corning, NY (US)

Correspondence Address: CORNING INCORPORATED, SP-TI-3-1, CORNING, NY, 14831

(21) Appl. No.: 09/969,570

(22) Filed: Oct. 1, 2001

Related U.S. Application Data
(60) Provisional application No. 60/257,341, filed on Dec. 20, 2000.
(60) Provisional application No. 60/274,803, filed on Mar. 9, 2001.
(60) Provisional application No. 60/295,360, filed on Jun. 1, 2001.

(51) Int. Cl. C03C 25/60

(52) U.S. Cl. 65/397; 65/398

(57) ABSTRACT

The invention relates to the manufacturing of a preform having at least one fluorine doped region. One method of the invention for producing the fluorinated preform includes heat treating a porous soot preform, the preform substantially devoid of any sintered glass layer, to a temperature of greater than about 1200° C. The method further includes exposing the preform to an atmosphere comprising a fluorine containing compound, wherein the time and the temperature of said exposing step is controlled so that Φ comprises≧about 1 wherein Φ is defined as Rₘₐₓ/(D/k)^{½}, wherein Rₘₐₓ is the outer radius of the preform, D is the diffusion coefficient of the fluorine containing compound into the preform, and k is the reaction rate constant of the reaction between the fluorine and the soot, thereby controlling the radial penetration of fluorine into the preform. A second method includes depositing fluorine doped silica soot on a starting member to form a soot preform having at least one fluorine doped soot region and heating the soot preform at a rate of more than about 10° C./min to a temperature of more than about 1300° C. A third method includes heating a preform having at least one region of fluorine doped soot at a rate of more than about 10° C./min to a temperature of more than about 1400° C.

### CROSS-REFERENCE To RELATED APPLICATIONS

The benefit of priority to the following applications, (1) U.S. patent application Ser. No. 60/257,341, filed Dec. 20, 2000 entitled Fluorine Doping A Soot Preform to Dawes et al., (2) U.S. patent application Ser. No. 60/274,803, filed Mar. 9, 2001 entitled Fluorine Doping A Soot Preform, and (3) U.S. patent application Ser. No. 60/295,360 filed Jun. 1, 2001 entitled Fluorine Doping A Soot Preform the content of which is relied upon and which are incorporated herein by reference in their entirety.

### BACKGROUND OF THE INVENTION

1. Field of the Invention

The present invention relates generally to the manufacturing of optical fibers, and particularly to manufacturing a fluorine doped preform which an optical fiber may be drawn from the preform.

2. Technical Background

Optical fibers have acquired an increasingly important role in the field of communications, frequently replacing existing copper wires. This trend has had a significant impact in the local area networks (i.e., for fiber-to-home uses), which has seen a vast increase in the usage of optical fibers. Further increases in the use of optical fibers in local loop telephone and cable TV service are expected, as local fiber networks are established to deliver ever greater volumes of information in the form of data, audio, and video signals to residential and commercial users. In addition, use of optical fibers in home and commercial business environments for internal data, voice, and video communications has begun and is expected to increase.

Optical fibers having a fluorine doped region have unique attributes in the areas of long haul optical fibers, dispersion compensating optical fibers, dispersion slope compensating optical fibers, and high data rate optical fibers. The ability to include fluorine in a preform is an important aspect of producing an optical fiber with a fluorine doped region.

Prior attempts to incorporate fluorine into the preform include depositing fluorine doped soot on a starting member. Typically, the starting member was a sintered core cane. However, in the past, deposited fluorine has exhibited significant migration from the region or regions of interest and loss, such that depositing fluorinated soot was not a practical manner to produce a fluorinated soot preform. Preforms fluorinated during deposition have exhibited a fluorine loss between forty (40%) percent to fifty (50%) percent during consolidation at traditional temperatures and ramp rates of 2 to 5° C./min. One reason for the low retention rate of fluorine is the production of the compound SiF₄ during deposition. Typically SiF₄ generated during deposition will volatilize off from the preform during consolidation. This has led to the use of unacceptable long consolidation periods in an effort to redope the preform with SiF₄ that is volatilized off during the consolidation period. However this effort to redope the preform has not been successful.

The relatively long times at the relatively low temperatures and the slow ramp consolidation, impact fluorine retention in at least two ways: (1) the fluorine containing vapor (mainly SiF₄) evolving from the soot has sufficient time to diffuse out of the preform; and (2) the equilibrium of redoping the preform with the SiF₄ vapor is not a favored reaction at the lower temperatures. Thus, deposition of fluorinated soot with a redoping step has not proven to be effective.

Fluorine may also be added to a soot preform during a consolidation doping step. In one such consolidation doping process, soot is deposited on a sintered preform forming a physical interface between a central core region of the optical fiber and the soot region.

The soot coated sintered preform is dried in a 2% chlorine containing atmosphere for 2 hours at 1000° C. The dried preform is exposed to a fluorine containing atmosphere for 1 to 4 hours at a temperature of 1100° C. to 1400° C. The fluorine doped preform is then sintered and drawn into an optical fiber. However, prior consolidation doping techniques have not demonstrated the ability to maintain a significant amount of fluorine in a desired region of the preform.

A need exists for alternative methods to produce preforms having at least one fluorine doped region which does not exhibit significant loss or migration of the fluorine.

### SUMMARY OF THE INVENTION

One aspect of the present invention is a method of making an optical fiber containing a fluorine doped region. The method includes heat treating a porous soot preform, preferably in an atmosphere substantially devoid of any halide containing compound, to a first temperature. The preform is preferably substantially devoid of any sintered glass layer. The method further includes exposing the preform to an atmosphere comprising a fluorine containing compound at a second temperature, wherein the rate of reaction between the fluorine and the soot and the rate of diffusion of the fluorine compound into the preform are both temperature dependent and the increase in the rate of reaction as a function of increasing temperature is greater than the increase in rate of diffusion as a function of increasing temperature, thereby controlling the radial penetration of fluorine into the preform.

Another aspect of the invention includes a method of heat treating a porous soot preform to a temperature of greater than about 1200° C. Preferably, the soot preform is substantially devoid of a sintered glass layer. The method further includes exposing the preform to an atmosphere comprising a fluorine containing compound, wherein the time and the temperature of said exposing step is controlled so that Φ comprises≧about 1 wherein Φ is defined as Rₘₐₓ/(D/k)^{½}, wherein Rₘₐₓ is the outer radius of the preform, D is the diffusion coefficient of the fluorine containing compound into the preform, and k is the reaction rate constant of the reaction between the fluorine and the soot, thereby controlling the radial penetration of fluorine into the preform.

A further aspect includes heat treating a porous soot preform to a temperature of at least about 1250° C. Preferably, the soot preform is substantially devoid of a sintered glass layer. The method also includes doping the soot blank with fluorine at a doping temperature of at least about 1300° C. such that a radial gradient of fluorine doping across the soot blank is great enough to result in a fiber having a change in delta, across a radial fluorine doped region, that is less than (“less than” is used above to mean more negative and not closer to zero) about −0.25% with respect to the cladding, where Δ_{a-b}=(nₐ²−n_{b}²)/(2nₐ²)×100%, nₐ being the refractive index of the fluorine-doped glass and n_{b} being the refractive index of the cladding.

Practicing the described aspects of the invention will result in the advantage of producing a fluorine doped soot preform in just one deposition step. The fluorine doped preform will have the advantage of not containing various physical interfaces. Another advantage of practicing the above described methods is that they may be used to preferentially dope one region of a soot preform and not dope another region of the preform. A further advantage that will result from practicing the above methods, is an efficient use of fluorine, due to the lack of fluorine migration and the ability to confine the fluorine to one specific area of the preform.

An additional aspect of the invention includes the deposition of at least one region of fluorine doped silica soot on a starting member to form a soot preform. This aspect of the invention further includes heating the soot preform at a rate of at least about 10° C./min to a temperature of more than about 1300° C. Preferably, the heat treating atmosphere is a non-fluorine containing atmosphere.

Another aspect of the invention includes heat treating a preform having a fluorine doped silica soot region. The fluorinated soot body may be formed by either the deposition of fluorine doped silica soot or by a consolidation doping process. The preform having at least one fluorine doped region is heated at a rate of more than about 10° C./min to a temperature of more than about 1400° C. Preferably the heating atmosphere comprises an inert gas.

A further aspect of the invention includes a method of making an optical fiber containing a fluorine doped region. The method includes depositing at least one region of fluorinated doped soot on a starting member forming a porous soot preform. The porous soot preform is heat treated to a temperature of greater than about 1200° C. for a period of at least about twenty minutes, wherein the time and the temperature of said heat treating step is controlled so that Φ comprises≧about 1 wherein Φ is defined as Rₘₐₓ/(D/k)^{½}, wherein Rₘₐₓ is the outer radius of the preform, D is the diffusion coefficient of the fluorine containing compound into the preform, and k is the reaction rate constant of the reaction between the fluorine and the soot, thereby controlling the radial penetration of fluorine into the preform.

Practicing the aforementioned aspects of the invention can be used to produce a fluorine doped soot preform that is doped during deposition. Advantages of the above aspects of the invention include reducing loss of fluorine and migration of deposited fluorinated soot to nominal amounts. The above method may be used to improve the uniformity of the refractive index of a fluorine doped region of the preform. Other advantages of practicing the above method include avoiding contaminating the central core region of the preform with fluorine, more fluorine dopant is incorporated into the preform and less dopant is lost in the effluent, and the drawn fiber may exhibit deeper index profiles than fibers previously fluorinated during deposition.

Furthermore, the aspects of the invention include another method of making an optical fiber containing at least one fluorine doped region. The method includes exposing a preform having at least one region of soot to a fluorine containing atmosphere in a furnace and heating the soot preform in the fluorine containing atmosphere from a first temperature to a doping temperature at a rate of more than 10° C. per minute. Preferably, the soot preform is heated a rate of at least about 20° C. per minute.

An additional aspect of the invention includes a further method of making an optical fiber containing at least one fluorine doped region. The method includes heat treating a porous soot preform, the preform substantially devoid of any sintered glass layer, from a first temperature to a second temperature. The temperature is increased from the first temperature to the second temperature at a rate of more than about 10° C. per minute. The method also includes doping at least one region of the preform with fluorine at a doping temperature of greater than about 1225° C.

Practicing the above aspect of the invention can be used to make an optical fiber which includes a fluorine doped section that has sharper edge profiles between the non-fluorine doped sections and the fluorine doped section than conventional manufacturing techniques. Practicing the above aspect of the invention has resulted in the advantage of minimizing fluorine migration from the fluorine doped region to adjacent non-fluorine doped regions. The minimization of migration eliminates the need for the resultant fiber to include one or more barrier layers. A further advantage of practicing the above aspect of the invention is that the core of an optical fiber having a fluorine doped region can be made from a preform that has undergone a single consolidation step. The above aspect of the invention may be used to preferentially dope one region of a preform with fluorine and not dope other regions of the preform with fluorine.

Another aspect of the invention includes another method of making an optical fiber containing at least one fluorine doped region. The method includes the steps of: (a) a first heating step of heating at least one region of a soot preform to a first temperature of more than about 1300° C. in a furnace; (b) cooling the at least one region of the soot preform to a cooling temperature above 1100° C., wherein the cooling temperature comprises a temperature lower than the first temperature; (c) exposing the soot preform to a fluorine containing atmosphere; and (d) a second heating step of heating the soot preform in the fluorine containing atmosphere to a second temperature, said second heating step comprises increasing the temperature in the furnace from the cooling temperature to the second temperature at a rate of more than 10° C. per minute. Preferably the rate of increase in temperature during the second heating step is more than about 20° C. per minute.

A further aspect of the invention is an additional method of making an optical fiber containing at least one fluorine doped region. The method includes the steps of: (a) a first heating step of heating at least one region of a soot preform to a first temperature in a furnace; (b) cooling the at least one region of the soot preform to a cooling temperature, in an atmosphere substantially devoid of chlorine, the cooling temperature comprises a temperature of less than the first temperature; (c) exposing the soot preform to a fluorine containing atmosphere; and (d) a second heating step of heating the soot preform in the fluorine containing atmosphere to a second temperature, the heating step comprises increasing the temperature in the furnace from the cooling temperature to the second temperature at a rate of more than 10° C. per minute.

Practicing the aforementioned aspects of the invention in a process for making an optical fiber with a fluorine doped section will result in various advantages. The core of the fiber, including the fluorine doped section, can be made from a single consolidation step. The number of processing steps and the handling of the preform is reduced. The use of scattering centers such as physical interfaces, e.g. barrier layers, is eliminated. An optical fiber manufactured in accordance with the above aspect of the invention is a low loss optical fiber and will exhibit excellent mechanical properties. The above aspect of the invention may be used to preferentially dope one region of a preform with fluorine and not dope other regions of the preform with fluorine.

Practicing any one of the aforementioned methods of the invention may be used to manufacture an optical fiber or cane having a fluorine doped region fiber having a “sharp” refractive index profile. Preferably, the fiber or cane will have a central core region with a higher refractive index than the refractive index of the fluorine doped region of the fiber or cane. Sharp as used herein refers to at least the slope of a plot of weight percent of fluorine in the preform in relation to the radius of the preform. Preferably, the slope of the plot has at least one segment with a slope with an absolute value of at least 2.5, more preferably at least about 3.0, even more preferably at least about 5.0 and most preferably at least about 16.0. The refractive index profile can be disclosed in various types of units, such as delta percent as a function of a normalized radius of the fiber or cane, Fluorine weight percent as a function of radius of cane or fiber, delta percent as a function of the radius of the cane, or any other appropriate units.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a schematic cross sectional view of a soot deposition process.

FIG. 2 is a schematic cross sectional view of a porous soot preform.

FIG. 3 is a graph of the reduction of pore size as a function of temperature and time for one embodiment of heat treating a porous soot preform.

FIG. 4 is a graph of the delta (Δ) percent of a cane that be can drawn from a preform made in accordance with the invention. The Δ% (y-axis) is stated as a function of a normalized radius (x-axis).

FIG. 5 is a graph of the the concentration of fluorine (y-axis) in a preform as a function of normalized radius (x-axis) in terms of the dimensionless parameter Φ.

FIG. 6 is a schematic cross sectional view of the deposition of cladding on a core cane.

FIG. 7 is a graph of the fluorine concentration of a cane (y-axis) in terms of delta (Δ%) percent as a function of a normalized radius (x-axis) of the cane.

FIG. 8 is a graph of the fluorine concentration of a cane (y-axis) in terms of delta (Δ%) percent as a function of a normalized radius (x-axis) of the cane.

FIG. 9 is a graph of the fluorine concentration (y-axis) as a function of radius (x-axis) of a preform (a test preform) heated to a sintering temperature at a rate of more than about 10° C./min.

FIG. 10 is a graph of the fluorine concentration (y-axis) as a function of radius (x-axis) of a preform (a control preform) heated to a sintering temperature at a rate of about 5° C./min.

FIG. 11 illustrates a cross sectional end view of a preform manufactured in accordance with the invention that includes one barrier layer.

FIG. 12 illustrates a cross sectional end view of a preform manufactured in accordance with the invention that includes more than one barrier layer.

FIG. 13 illustrates the thermal profile of the fluorine doping of a soot preform in accordance with one aspect of the invention.

FIG. 14 illustrates the thermal history of a muffle in a furnace for making a sintered preform in accordance with one aspect of the invention.

FIG. 15 illustrates the thermal profile of a soot preform prior to fluorine doping of the preform in accordance with one aspect of the invention.

FIG. 16 is a graph of the fluorine concentration of a cane (y-axis) in terms of delta (Δ%) percent as a function of a normalized radius (x-axis) of the cane for a cane made in accordance with one aspect of the invention.

FIG. 17 is a graph of the fluorine concentration of a cane (y-axis) in terms of delta (Δ%) percent as a function of a normalized radius (x-axis) of the cane for a cane made in accordance with one aspect of the invention.

FIG. 18 is a graph of the fluorine concentration of a cane in terms of weight percent (y-axis) as a function of a normalized radius (x-axis) of the cane for a cane made in accordance with the invention.

FIG. 19 is a graph of the fluorine concentration of a cane (y-axis) in terms of delta (Δ%) percent as a function of a normalized radius (x-axis) of the cane for a cane made in accordance with one aspect of the invention.

### DETAILED DESCRIPTION OF THE INVENTION

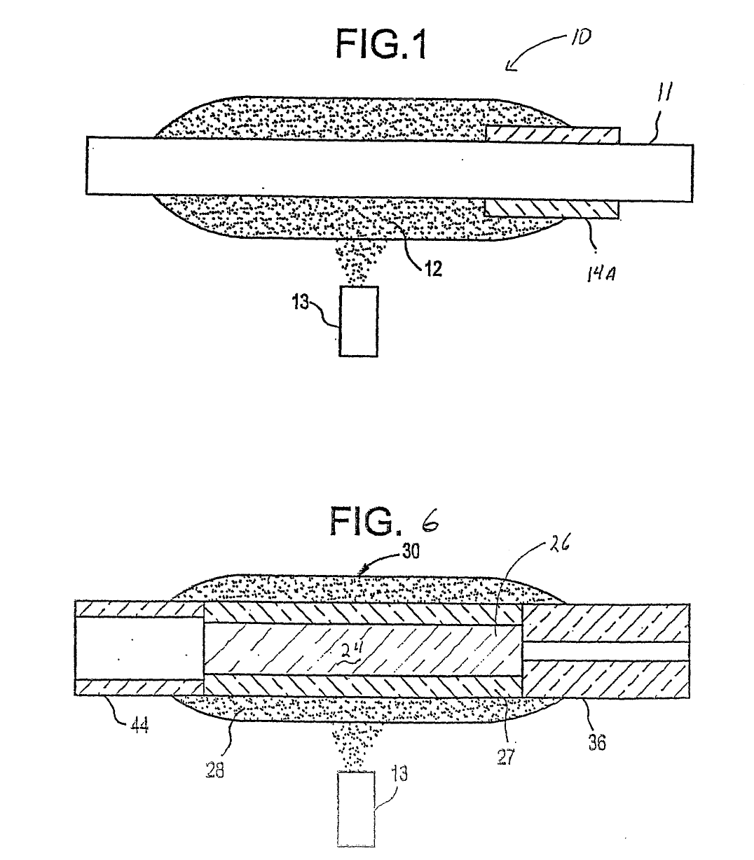

Reference will now be made in detail to the present preferred embodiments of the invention, examples of which are illustrated in the accompanying drawings. Wherever possible, the same reference numbers will be used throughout the drawings to refer to the same or like parts. An exemplary embodiment of a soot preform for use in the present invention is shown in FIG. 1, and is designated generally throughout by reference numeral 10.

As shown in FIG. 1, a soot preform 12 is formed from a chemical vapor deposition (“CVD”) process. Preform 12 can be formed by various CVD processes such as outside vapor deposition (“OVD”), vapor axial deposition (“VAD”), modified chemical vapor deposition (“MCVD”), and plasma chemical vapor deposition (“PCVD”). In FIG. 1, soot is deposited via OVD, from burner 13 onto a starting member 11 to form preform 12. The starting member is preferably an aluminum mandrel. Also shown is a handle 14A attached to starting member 11.

Preferably, the soot being deposited is silica based soot. More preferably, preform 12 may have one or more regions of doped silica soot. For example, but not limited to, a radial region of the preform may be silica soot doped with at least one of the following elements Ge, P, Al, B, Ga, In, Sb, Er, Li, Na, K, Rb, Cs, Be, Mg, Ca, Sr, Ba, Ti, Se, Te, Fr, Ra, Bi, or mixtures thereof. Preform 12 may also have one or more regions of undoped silica soot. It is most preferred that an outer region of preform 12 is undoped silica soot. In one preferred embodiment of preform 12, preform 12 is formed by depositing a first region of silica soot doped with a refractive index increasing dopant, followed by a second region of silica soot. In a second preferred embodiment of preform 12, preform 12 is formed by depositing a first region of silica soot doped with a refractive index increasing dopant, such as germanium (e.g. having a Δ₁), a second region of silica soot having little or no germanium dopant (e.g. having a Δ₂), a third region of germanium doped silica soot (a.k.a. ring region) (e.g. having a Δ₃), and a fourth region of silica soot (e.g. having a Δ₄), wherein Δ₁>Δ₃>Δ₂>Δ₄. Each respective delta is calculated in accordance with the following formula: Δₐ=(nₐ²−n_{b}²)/(2nₐ²)×100%, nₐ being the refractive index of a particular region of the optical fiber, such as regions 1, 2, 3, or 4 and n_{b} being the refractive index of the cladding.

It is also preferred that soot preform 12 is porous with a substantially constant density. Preform 12 should have a density of less than about 2.1 g/cm³. Preferably, preform 12 has a density of about 0.1 to about 1.2 g/cm³, more preferably about 0.2 to about 0.8 g/cm³, most preferably about 0.4 to about 0.6 g/cm³. Preferably, the above density is the preform density after deposition and before any subsequent processing. Preferably, the above density is a localized density. A localized density is defined herein as a density of a predetermined portion of the preform for a predetermined volume of the preform, e.g. about one cubic centimeter sample of the preform. It is further preferred that preform 12 is substantially devoid of any physical interface or sintered glass regions. An example of a physical interface would include a barrier layer such as an annular region of sintered glass in the preform. More preferably, soot preform 12 is formed in a single deposition step.

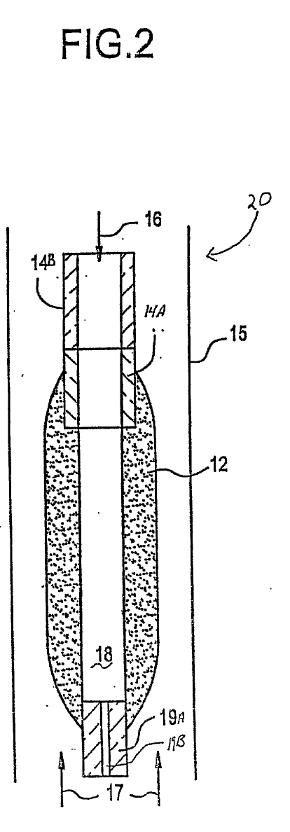

As designated by reference numeral 20 in FIG. 2, preform 12 is suspended in a furnace 15. As shown in FIG. 2, a ball joint 14B is attached to handle 14A. Preform 12 also includes a center passageway 18 and a plug 19A with an optional capillary tube 19B. Plug 19A and ball joint 14B are not required to practice the invention.

Preferably, soot preform 12 is heat treated in furnace 15 in an atmosphere preferably substantially devoid of any halide containing compound to a first temperature, after an optional drying step. More preferably, the atmosphere comprises an inert atmosphere, such as an atmosphere of He, Ar, N₂, or mixtures thereof. The first temperature comprises a temperature of about 1200° C. or more. Preferably the first temperature comprises a temperature above about 1240° C., more preferably above about 1280° C., most preferably above about 1300° C. It also preferred that the first temperature is not above about 1350° C. Preferably preform 12 is maintained at the first temperature for at least about thirty (30) minutes, more preferably at least about forty-five (45) minutes. It is further preferred that the heat treating step lasts for a sufficient period of time such that preform 12 reaches an isothermal temperature. Isothermal temperature is used here into describe a preform without a radial temperature gradient that is greater than about 5° C./cm, more preferably not greater than about 2° C./cm, and most preferably 0° C./cm.

Preferably, the heat treating step results in a reduction in an average pore size of the pores of the preform of at least about twenty (20%) percent, further preferred at least about thirty (30%) percent, more preferably at least about forty (40%) percent, and most preferably at least about fifty (50%) percent. Typically, preform 12 will have pores of about 0.1 to about 1.0 μm, preferably, the pore size after heat treating may range from about 0.05 to about 0.8 μm depending on the starting size of the pore.

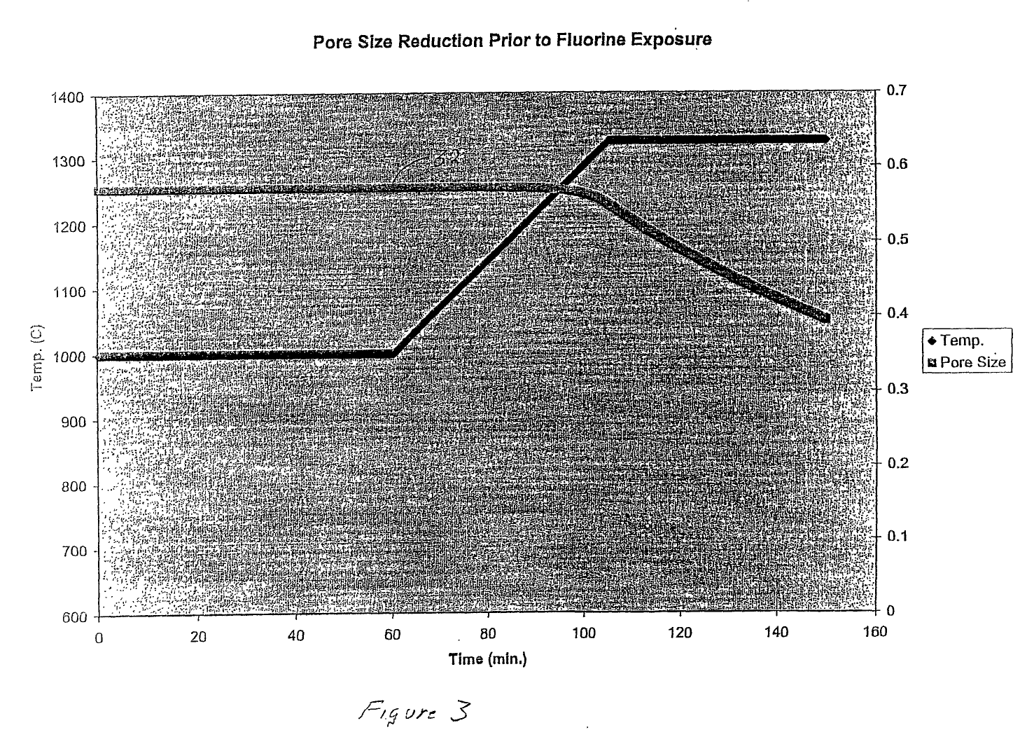

The reduction in average pore size for one embodiment of the aforementioned heat treating step is shown in FIG. 3. In the embodiment illustrated in FIG. 3, prior to fluorine doping a soot preform, the preform was maintained at a temperature of about 1000° C. for about sixty (60) minutes, at which time the preform was dried as explained below. The drying gas was then purged from the furnace and the preform was heated to a temperature of about 1340° C. in a period of about forty-five (45) minutes. The preform then was maintained at a temperature of about 1340° C. for about forty-five (45) minutes.

The pores of the preform were about 0.58 μm until the preform reached the temperature of about 1260° C., as indicated by line 32. Once the preform was at a temperature of about 1260° C., the pores of the preform started to shrink from about 0.58 μm to less than about 0.40 μm, preferably about 0.39 μm. The above pores sizes are average pores determined from the density of preform 12. The evolution of the density of the perform can be determined in accordance with the Mackenzie-Shuttleworth model, as explained in “A Phenomenological Theory of Sintering”, Proc. Phys. Soc., (London), 62 (Section B) 833-852 (1949) and Scherer model as explained in “Sintering of Low Density Glasses: I. Theory”, J. Amer Ceramic Soc., 60 (5-6) 236-239 (1977), both of which are incorporated herein by reference.

Preferably after the heat treatment at the first temperature, preform 12 is exposed to an atmosphere comprising a fluorine containing compound at a second temperature, wherein the rate of reaction between the fluorine and the soot and the rate of diffusion of the fluorine compound into the preform are both temperature dependent and the increase in the rate of reaction as a function of increasing temperature comprises more than the increase in rate of diffusion as a function of increasing temperature, thereby controlling the radial penetration of fluorine into the preform. One example of a preferred reaction rate is R(k)=e^{-C1/T} wherein “R(k)” is the reaction rate, “C1” is a constant, and “T” is temperature and a preferred diffusion rate is R(D)=C2*T/^{½} wherein “R(D)” is the diffusion rate, “C2” is a constant, and “T” is temperature. In this example, the reaction rate will increase in magnitude much greater than the diffusion rate as the temperature increases.

Preferably, the atmosphere includes at least one gas which includes at least one fluorine containing compound selected from the group consisting of CF₄, SiF₄, C₂F₆, SF₆, F₂, C₃F₈, NF₃, ClF₃, BF₃, SOF₂, SO₂ClF, chlorofluoro-carbons, and mixtures thereof. Preferably, the gas contacts preform 12 in the direction of arrows 17. Preferably, preform 12 is exposed to the fluorine containing atmosphere for at least about twenty (20) minutes, more preferably at least about ninety (90) minutes, and most preferably no more than about four (4) hours.

Preferably, the pressure in furnace 15 during said exposure is about atmospheric pressure. Preferably, the second temperature comprises at least about 1225° C., more preferably at least about 1275° C., most preferably at least about 1300° C. It is also preferred that the second temperature is not above about 1350° C. The second temperature may also be referred to as a doping temperature. The preform may be doped under isothermal conditions or non-isothermal conditions in accordance with the previous definition of isothermal provided above. The first temperature and the second temperature may be about the same temperature or different temperatures. For example both the first and the second temperature can be about 1300° C. or the first temperature may be about 1300° C. and the second temperature may be about 1250° C. The above temperatures of about 1300° C. and about 1250° C. are recited for illustrative purposes only and the invention should not be limited to these temperatures.

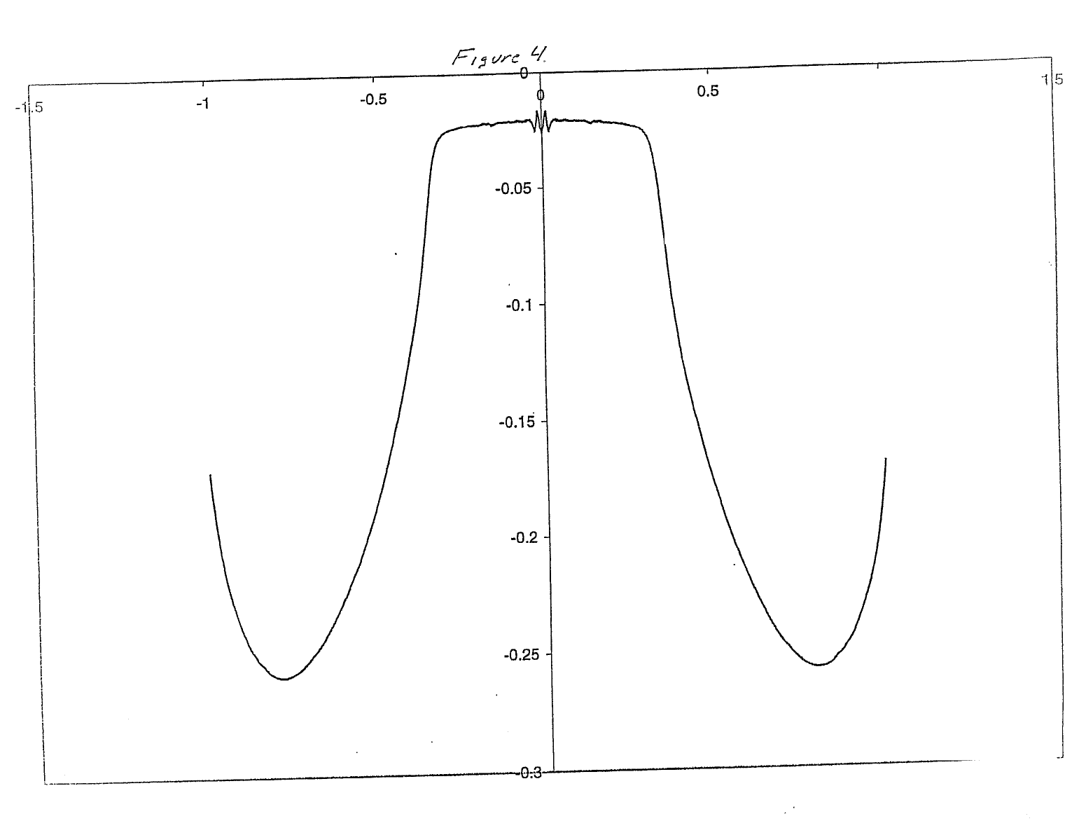

It is further preferred that the fluorine is reacting in the soot preform before the fluorine containing compound has an opportunity to diffuse into the soot preform past the region of the soot preform that is desired to be doped with fluorine. For example it is desired that the preform has an outer annular region of fluorine which comprises the outer 30% of the radius of the preform. For the preform to be preferentially doped with fluorine, the fluorine in the fluorine containing compound will react with the soot in the preform before the fluorine containing compound can diffuse beyond more than about 30% of the outer radius of the preform. A person skilled in the art will realize that the preform radius is being provided in terms of a normalized radius and that the preform is doped from an outer edge toward the center of the preform. This is further illustrated in FIG. 4.

To preferentially dope a preform with fluorine, the rate of reaction of bonding fluorine to the silicon of the silica soot must be faster than the rate of diffusion of the fluorine containing compound into the preform. Relatively uniform doping can occur when the diffusion rate is faster than the reaction rate. By preferentially doping one region of the preform instead of another region of the preform, the radial penetration of fluorine into the preform is controlled.

Typically for preferential doping the diffusion and reaction rates are both temperature dependent, however, the reaction rate is more temperature dependent than the diffusion rate. As such, higher temperatures impact the reaction rate more than the diffusion rate, such as, for example, temperatures of more than about 1225° C., more preferably more than about 1280° C., most preferably about 1300 to about 1325° C. However, the invention is not limited to controlling the rate of reaction and rate of diffusion by the use of temperature. The invention can be practiced by any methodology that may be used to increase the reaction rate and/or decrease the diffusion rate.

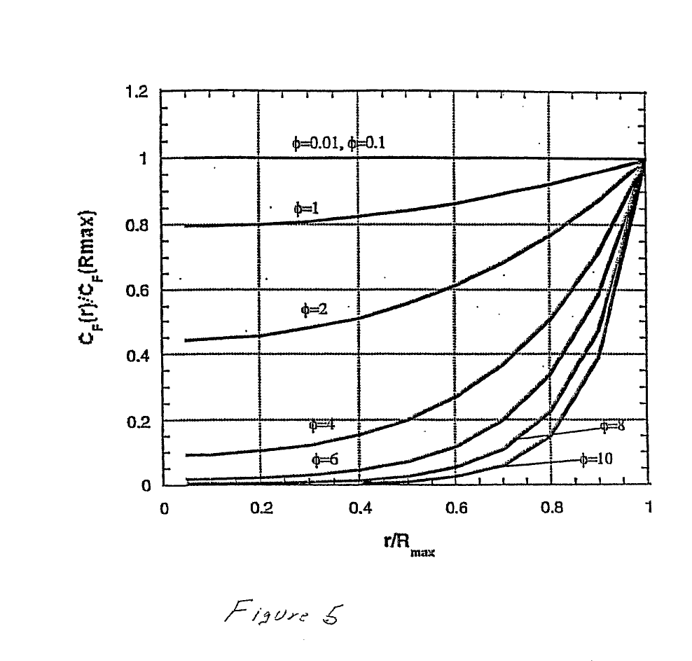

Preferential doping of preform 12 is further explained in FIG. 5. In FIG. 5, the concentration of fluorine (y-axis) is plotted as a function of a normalized radius of the cane. For illustrative purposes the fluorine doping reaction is characterized by first order kinetics, parameter Φ is defined as Rₘₐₓ/(D/k)^{½}, wherein “Rₘₐₓ” is the outer radius of the preform, “D” is the diffusion coefficient, and “k” is the reaction rate constant, preferably the first order reaction rate constant. For doping to be preferential, Φ should be equal to or greater than 1, i.e. k must be larger than D. If Φ is less than about 1, doping of the preform will be uniform (non-preferential). As shown in FIG. 5, the concentration of fluorine in preform 12 is shown as a function of radius of the preform. The radius of the preform is a normalized radius. Therefore, the outer edge of the preform has a radius of about 1 and the center of the preform has a radius of about 0. As shown in the FIG. 5, as the value of Φ is greater than about 1, the concentration of fluorine in the preform decreases towards the center of the preform.

However, the fluorine doping reaction is not required to be a first order reaction. In another embodiment of the invention, the incorporation of fluorine into the soot preform blank scales with fluorine dopant concentration with ¼ exponent. The following equation could be used to determine the amount of fluorine incorporated locally into the preform:

F=K_{eq}(T)([fluorine dopant]^{¼}).

F is the amount of fluorine incorporated into a local region of the preform. Keq is the equilibrium constant of the reaction of fluorine with the soot preform, which is a function of temperature (T) and “[fluorine dopant]” is the local concentration of the fluorine dopant at the time of the doping. The word “local” is used above to describe the concentration of the fluorine at any point along a radial cross section inside the preform.

The incorporation of the fluorine into a preform in accordance with the above equation 1 is shown in FIG. 19. An embodiment of the invention that can be used to replicate the figure includes doping the preform 12 with SiF₄ at a temperature of about 1350° C. The mole fraction of SiF₄ in the doping atmosphere is about 0.15. The doping period was about three (3) hours.

As illustrated in FIG. 19, at a high temperature, such as a temperature of about 1350° C., the reaction rate is faster than the diffusion rate which equates to the fluorine dopant reacting with preform 12 before the dopant can diffuse into an inner region of preform 12. For the example illustrated in preform 12, the inner region of preform 12 is the inner most forty (40%) percent of preform 12.

Optionally, prior to heat treating preform 12 at the first temperature, soot preform 12 may be dried in an atmosphere containing a chlorine drying gas. A preferred drying atmosphere contains up to two (2) percent C1₂ and an inert gas. More preferably, the drying gas contacts preform 12 in the direction of arrows 16 and 17 of FIG. 2. Preferably, the temperature of the drying atmosphere is between about 800 to about 1100° C. Preferably, the drying step lasts from about thirty (30) minutes to about four (4) hours, more preferably about two (2) hours. Preferably, the drying step is concluded with an inert gas purge of the furnace 15. Preferred purge gases include helium, nitrogen, argon, or mixtures thereof. However, any known inert gas may be used as the purge gas. The purge gas should contact the preform in the same manner as the drying gas.

Preform 12 may be sintered and the sintered preform may be drawn into a cane. Preform 12 may be sintered by heating preform 12 to a sufficient temperature and for a sufficient time to condense perform 12 into a sintered glass rod. The sintering temperature may vary between about 1200 and about 1600° C. depending on such factors as the amount of fluorine contained in preform 12 and the duration of the sintering step. More preferably, the sintering temperature is between about 1400 and about 1600° C. Preferably the sintering step may last from about thirty (30) minutes to about six (6) hours, more preferably about two (2) to about four (4) hours. However, the sintering time period may vary depending on the sintering temperature, the size and density of the preform, and the chemical composition of the preform.

During sintering, passageway 18 can be closed by the condensing of the soot. If additional forces are needed to close passageway 18, vacuum may be pulled on passageway 18 during sintering. Sintering may occur in the same furnace as the prior steps or in a different furnace. The sintered preform can be drawn into a cane by heating the sintered preform to a temperature of about 1600° C. or more and drawing the sintered preform into cane having a smaller diameter than sintered preform 12. More preferably, the sintered preform is heated to at least about the glass softening point of preform 12. Alternatively, sintered preform 12 may be drawn into an optical fiber.

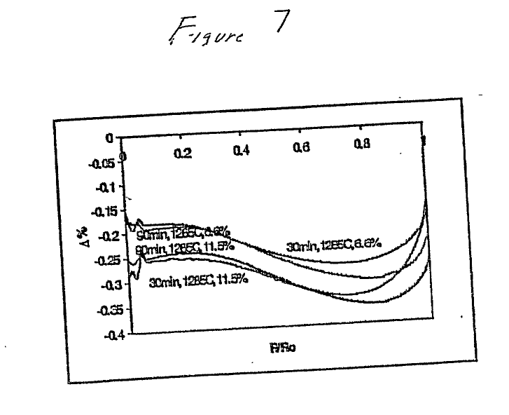

As shown in FIG. 6, generally designated 30, optionally additional soot may be deposited on cane 24 as a cladding 28 in accordance with aforementioned CVD processes. Cane 24 includes a central core region 26 and a fluorine doped region 27. The central core region may include one or more doped regions wherein the dopant is any of the aforementioned soot dopants as described above and also include one or more undoped regions. The fluorine doped region can be formed as described above. Also shown in FIG. 6 is a handle 44 and a plug 36. Handle 44 and plug 36 are the same as the handle and plug described in FIG. 2.

Once the soot deposited onto cane 24 is sintered, cane 24 may be drawn into an optical fiber. Preferably, the core/clad ratio of sintered preform 24 is about 0.5 or less. The preform or cane is drawn into an optical fiber by heating the preform or cane to at least the glass softening point. Typically, this is a temperature of at least about 1800° C. Known techniques of drawing the preform or cane into an optical fiber can be utilized.

One particular advantageous embodiment of the above described method for making a fluorine doped preform includes heat treating porous soot preform 12 in an atmosphere substantially devoid of any halide containing compound to a temperature of at least about 1250° C. The embodiment further includes doping preform 12 with fluorine at a doping temperature of at least about 1300° C. such that a radial gradient of fluorine doping across the soot blank is great enough to result in a fiber having a change in delta, across a radial fluorine doped region, that is less than (more negative) about −0.25% with respect to the cladding, where Δ_{a-b}=((nₐ²−n_{b}²)/(2nₐ²))×100%, nₐ being the refractive index of the fluorine-doped glass and n_{b} being the refractive index of the cladding, as shown in FIG. 4. Preferably, the cladding comprises silica. Preferably, the doping temperature comprises at least about 1320° C. It is further preferred that the thickness of the fluorine doped region of preform 12 is less than about 80% of the radius for the entire preform for forming cane 24, more preferably less than about 60%. It is further preferred that the radius of the fluorine doped region is an outer region of preform 12. For example, if the radius of the preform is about 100 cm, the fluorine doped region will start at a distance of at least about 20 cm away from the center of the preform and extend to an outer surface of the preform. Preferably, the change in delta is about −0.28% or less, more preferably about −0.35% or less.

FIG. 4 is a graph of the delta (Δ%) percent of a cane manufactured in accordance with the above method. The cane had a pure silica central core region with a radius of about 0.3 (30% of the normalized radius of the preform). A fluorine doped region extends from about 0.3 to about 1.0 (100% of the normalized radius of the preform). The fluorine region has a Δ% of about of less than about −0.25%.

The inventive cane, in a porous preform state, was dried in a chlorine containing atmosphere at a temperature of about 1000° C., as previously explained, and then heat treated to a temperature of about 1320° C. for about forty-five (45) minutes. The time period to increase the temperature from about 1000 to about 1320° C. was about forty-five (45) minutes. The preform was held at the temperature of about 1320° C. for about forty-five (45) minutes and subsequently exposed to an atmosphere containing CF₄ and He, in a flowrate ratio of more than about 1:3 slpm for about thirty (30) minutes. Preferably flowrates of CF₄ and He are 5 slpm of CF₄ and 16 slpm of He.

Another aspect of the invention relates to heat treating a preform that has already been fluorinated. In this aspect of the invention, the preform may be formed in the same manner as preform 12 shown in FIG. 1, however, at least one region of fluorine doped soot is deposited on starting member 11. The preform 12 may be formed by any of the aforementioned CVD techniques. CVD techniques include at least OVD, VAD, MCVD, and PCVD. For this aspect of the invention, preform 12 may include various regions of doped and undoped soot and preferably at least one region of fluorine doped soot. Preferably soot precursors include silica precursor SiCl₄ and fluorine precursors such as CF₄, SiF₄, C₂F₆, SF₆, F₂, C₃F₈, NF₃, CIF₃, BF₃, chlorofluoro-carbons, and mixtures thereof. It is more preferred if preform 12 includes at least one region of soot doped with at least one of the following elements consisting of Ge, Sb, P, Bi, Li, Na, K, Rb, Cs, Fr, Be, Mg, Ca, Sr, Ba, Ra, and mixtures thereof.

Fluorinated preform 12 is heat treated in furnace 15 to a temperature of more than about 1300° C. and the temperature is increased at a rate of more than about 10° C./min to the more than about 1300° C. The atmosphere in furnace 15 is preferably a non-fluorine containing atmosphere, more preferably a non-halide containing atmosphere, and most preferably an inert atmosphere as previously described. Preferably, the temperature in the furnace of the heat treating comprises at least about 1350° C., more preferably at least about 1400° C., and most preferably at least about 1450° C. Preferably the rate of increase of the temperature to the heat treating temperature (about 1300° C., preferably about 1350° C., more preferably about 1400° C., and most preferably about 1450° C.) comprises at least about 20° C./min, more preferably at least about 25° C./min, and most preferably at least about 40° C./min. The heat treating step may further comprise sintering preform 12. Optionally, preform 12 may be dried with a chlorine containing gas as described above before the heat treating step.

If desired, the aforementioned method may be incorporated into manufacturing preforms having a physical interface such as a barrier layer.

An alternate aspect of invention includes heat treating preform 12 to a temperature of more than about 1400° C. at a rate of more than about 10° C./min. Preferably the atmosphere in the furnace during the heating step comprises an inert gas. Preferably, the temperature comprises more than about 1450° C. It is also preferred that the atmosphere comprises an atmosphere substantially devoid of any reactive material. In this aspect of the invention, fluorinated soot preform 12 may be fluorinated during soot deposition or during consolidation as previously described.

Preform 12 may be sintered and the sintered preform may be drawn into a cane, as discussed above. Preform 12 may be sintered by heating preform 12 to a sufficient temperature and for a sufficient time to condense perform 12 into a sintered glass rod. The sintering temperature may vary between about 1200 and about 1600° C. depending on such factors as the amount of fluorine contained in preform 12 and the duration of the sintering step. More preferably, the sintering temperature is between about 1400 and about 1600° C. Preferably the sintering step may last from about thirty (30) minutes to about six (6) hours, more preferably about two (2) to about four (4) hours. However, the sintering time period may vary depending on the sintering temperature, the size and density of the preform, and the chemical composition of the preform.

As shown in FIG. 6, generally designated 30, optionally additional soot may be deposited on cane 24 as a cladding 28 in accordance with aforementioned CVD processes. Cane 24 includes, at least, a central core region 26 and a fluorine doped region 27. The central core region may include one or more doped regions wherein the dopant is any of the aforementioned soot dopants as described above and also include one or more undoped regions. The fluorine doped region can be formed as described above. Also shown in FIG. 6 is a handle 44 and a plug 36. Handle 44 and plug 36 are the same as the handle and plug described in FIG. 2.

Optical fibers which have been made in accordance with the above methods of heating treating a fluorinated soot body have exhibited excellent retention of fluorine in the soot. The above methods control the reaction between Si and F such that only nominal amounts of the volatile compound SiF₄ are formed during the fluorine doping reaction. Thus only minute amounts of fluorine are volatilized off as SiF₄ during fluorine doping or subsequent processing. The above method of consolidating a soot preform under a rate of more than about 10° C./min has lead to a reduction in the amount of fluorine lost during consolidation. Preferably no more than about twenty percent (20%) of the fluorine is lost during consolidation, more preferably no more than about fifteen percent (15%), and most preferably no more than about ten percent (10%). Also none of the methods include a source of H, therefore there is no loss of fluorine due to the formation of HF.

A further aspect of the invention relates to heat treating a preform that has already been fluorinated. In this aspect of the invention, the preform may be formed in the same manner as preform 12 shown in FIG. 1, however, at least one region of fluorine doped soot is deposited on starting member 11. For this aspect of the invention, preform 12 may include various regions of doped and undoped soot and preferably at least one region of fluorine doped soot. Preferably soot precursors include silica precursor SiCl₄ and fluorine precursors such as CF₄, SiF₄, C₂F₆, SF₆, F₂, C₃F₈, NF₃, CIF₃, BF₃, chlorofluoro-carbons, and mixtures thereof. A non-exhaustive list of chlorofluoro-carbons include SiCl₃F, SiCl₂F₂, and SiClF₃. It is more preferred if preform 12 includes at least one region of soot doped with at least one of the following elements consisting of Ge, Sb, P, Bi, Li, Na, K, Rb, Cs, Fr, Be, Mg, Ca, Sr, Ba, Ra, and mixtures thereof.

A preferred embodiment of preform 12, for this aspect of the invention, includes a first central region of germanium doped silica soot, a second region of undoped silica soot surrounding the first central region, and a third region of fluorine doped silica soot surrounding the second region. However, the preform 12 is not required to include a region doped with a refractive index increasing dopant, e.g. germanium, to practice the invention. The preform 12 may be formed by any of the aforementioned CVD techniques. CVD techniques include at least OVD, VAD, MCVD, and PCVD. In forming any embodiment of preform 12 having at least one up-doped region and at least one down-doped region, preferably each down-doped region is separated apart from each up-doped region by at least one region of undoped silica soot. The term up-doped is used above to describe a region of a preform that includes a refractive index increasing dopant, e.g. germanium, and the term down-doped is used above to describe a region of a preform that includes a refractive index decreasing dopant, e.g. fluorine.

Optionally, preform 12 may include a barrier layer as described in U.S. patent application Ser. No. 60/258,132, filed Dec. 22, 2000, the specification of which is incorporated herein. Exemplary techniques that may be used to form the barrier layer include fire polishing, induction heating, and laser treatment of a region of silica soot of preform 12, more preferably, the region of silica soot is not doped.

Conventional methods of consolidating and sintering preform 12 vaporizes the fluorine in the soot and the fluorine in the vapor state diffuses through preform 12 prior to preform 12 being sintered into a non-porous body. This aspect of the invention includes controlling the consolidation process to react the gaseous fluorine with silica in preform 12 before the gaseous fluorine will diffuse from preform 12. Preferably, the gaseous fluorine is reacted with silica to form compounds that contain less than about four (4) fluorine elements, more preferably the gaseous fluorine is reacted with undoped silica soot.

Diffusion and reaction rates are both temperature dependent, however, the reaction rate is more temperature dependent than the diffusion rate. As such, higher temperatures impact the reaction rate more than the diffusion rate, such as, for example, temperatures of more than about 1225° C., more preferably more than about 1280° C., most preferably about 1300 to about 1325° C. However, the invention is not limited to controlling the rate of reaction and rate of diffusion by the use of temperature. The invention can be practiced by any methodology that may be used to increase the reaction rate and/or decrease the diffusion rate.

Controlling the diffusion of fluorine in preform 12 can be further explained in FIG. 5. In FIG. 5, the concentration of fluorine (y-axis) is plotted as a function of a normalized radius of the cane. For illustrative purposes the fluorine doping reaction is characterized by first order kinetics, parameter Φ is defined as Rₘₐₓ/(D/k)^{½}, wherein “Rₘₐₓ” is the outer radius of the preform, “D” is the diffusion coefficient, and “k” is the reaction rate constant, preferably the first order reaction rate constant. For doping to be preferential, Φ should be equal to or greater than 1, i.e. k must be larger than D. If Φ is less than about 1, doping of the preform will be uniform (non-preferential). As shown in FIG. 5, the concentration of fluorine in preform 12 is shown as a function of radius of the preform. The radius of the preform is a normalized radius. Therefore, the outer edge of the preform has a radius of about 1 and the center of the preform has a radius of about 0. As shown in the FIG. 5, as the value of Φ is greater than about 1, the concentration of fluorine in the preform decreases towards the center of the preform. Preferably, “Φ” is greater than about 2 and more preferably greater than about 10.

In this aspect of the invention, the consolidation of preform 12 is controlled. The preform is heated treated at a temperature of more than about 1200° C., preferably at least more than about 1225° C., more preferably more than about 1280° C., and most preferably about 1300 to about 1325° C. It is preferred that the preform is not heat treated at a temperature of more than about 1350° C. The preform is heat treated at the temperature for at least about thirty (30) minutes, preferably at least about sixty (60) minutes, more preferably at least about ninety (90) minutes, and most preferably at least about four (4) hours. Preferably the preform is not heat treated for a temperature of more than about six (6) hours. As for raising the temperature of the preform to the heat treating temperature, preferably the temperature of the preform is increased to the heat treating temperature quickly. Preferably, the temperature of preform 12 is raised to the heat treating preform in a period of less than about sixty (60) minutes, preferably less than about thirty (30) minutes, and more preferably less than about twenty (20) minutes. It is further preferred that the pressure during the heat treating step is about atmospheric pressure.

After preform 12 is heat treated, preform 12 may sintered as mentioned above. Preform 12 may be sintered and the sintered preform may be drawn into a cane. Preform 12 may be sintered by heating preform 12 to a sufficient temperature and for a sufficient time to condense perform 12 into a sintered glass rod. The sintering temperature may vary between about 1200 and about 1600° C. depending on such factors as the amount of fluorine contained in preform 12 and the duration of the sintering step. More preferably, the sintering temperature is between about 1400 and about 1600° C. Preferably the sintering step may last from about thirty (30) minutes to about six (6) hours, more preferably about two (2) to about four (4) hours. However, the sintering time period may vary depending on the sintering temperature, the size and density of the preform, and the chemical composition of the preform.

As shown in FIG. 6, generally designated 30, optionally additional soot may be deposited on cane 24 as a cladding 28 in accordance with the aforementioned CVD processes. Cane 24 includes a central core region 26 and a fluorine doped region 27. The central core region may include one or more doped regions wherein the dopant is any of the aforementioned soot dopants as described above and also include one or more undoped regions. The fluorine doped region can be formed as described above. Also shown in FIG. 6 is a handle 44 and a plug 36. Handle 44 and plug 36 are the same as the handle and plug described in FIG. 2.

Alternatively, instead of drawing the sintered preform into a cane, the sintered preform may be drawn into a fiber as mentioned above.

Optionally, prior to heat treating preform 12, soot preform 12 may be dried in an atmosphere containing a drying gas including a chlorine containing compound. Preferably, the chlorine containing compounds include SiCl₄ or GeCI₄. Preferably, fluorine in the soot preform 12 will bond with the Si or Ge element in the chlorine containing compound, during the drying treatment.

More preferably, the drying gas contacts preform 12 in the direction of arrows 16 and 17 of FIG. 2. Preferably, the temperature of the drying atmosphere is between about 800 to about 1100° C. Preferably, the drying step lasts from about thirty (30) minutes to about four (4) hours, more preferably about two (2) hours. Preferably, the drying step is concluded with an inert gas purge of the furnace 15. Preferred purge gases include helium, nitrogen, argon, or mixtures thereof. However, any known inert gas may be used as the purge gas. The purge gas should contact the preform in the same manner as the drying gas.

In accordance with an embodiment of this aspect of the invention, at least one glassy barrier layer (e.g., 135a) is formed in the soot preform during the deposition step. As illustrated in FIG. 11, the glassy barrier layer 135a is preferably a thin layer of vitrified glass. The barrier layer 135a functions to substantially minimize the migration of any dopant (as well as water (H, OH) present between segments of the soot preform, for example between a first and second annular segments 140, 142. The term “glassy” as used herein encompasses both fully vitrified glass as well as a partially vitrified glass. The layer only needs to be sufficiently vitrified (glassy) to substantially minimize migration of the dopant and/or water.

In one embodiment, the glassy barrier layer 135a is formed by subjecting the thin layer of soot to sufficient heat to fully vitrifying it into a consolidated glass. First, a first soot segment 140 is formed. A first portion of the first soot segment is then vitrified to form the at least one glassy barrier layer 135a. Finally, prior to consolidation of a remaining portion of the first soot segment 140, a second soot segment 142 is deposited onto the at least one glassy barrier layer 135a. The glassy barrier layer 135a is effective at reducing the migration of any dopant, such as fluorine, from one segment to the other segment adjacent to the barrier. It should be understood that not only may the glassy barrier layer be formed on an outer radial periphery of the first soot segment, but it also may be formed on an inner radial periphery of the second soot segment. Barriers are particularly important when fluorine is present in an amount greater than 1.0% by weight in at least a portion of the segment. The glassy barrier layer has the distinct advantage of allowing the manufacture of sharp segment transitions in the consolidated preform. Sharp, non-rounded, transitions resultantly improve both fiber attenuation and bend performance.

Preferably, the glassy barrier layer 135a has a thickness of less than about 200 μm, more preferably less than about 100 μm, more preferably yet, less than about 30 μm, and most preferably between about 10 μm and 20 μm. In the embodiment shown in FIG. 11, the glassy barrier layer 135a is formed within the soot preform 120a and includes soot on both the inner and outer radial sides thereof. Preferably, the barrier layer 135a is formed along the entire length of the preform, thus forming a tubular shaped structure. Optionally the barrier 135a may even be formed over an unusable end portions of the preform.

Barrier layers are particularly effective at minimizing the migration of fluorine, which is generally very mobile because of its small molecular size and activity. Thus, if, for example, in FIG. 11, the second soot segment 142 includes a fluorine dopant, then the barrier layer 135a will minimize the migration of fluorine from the second segment 142 into the first soot segment 140.

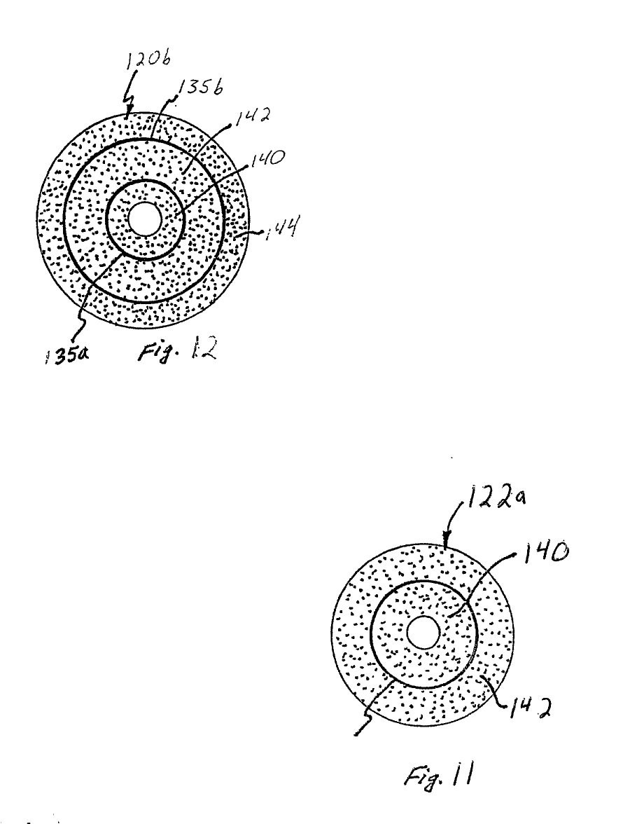

In accordance with another embodiment of the invention, multiple barrier layers may be employed in optical fiber soot preforms. Such multi-barrier layers are useful in the manufacture of multi-segment core preforms, for example. In FIG. 12, a third soot segment 144 is laid down adjacent to the second soot segment 142 and over a second barrier layer 135b. The second barrier layer 135b prevents any dopants from migrating out of the soot layer 142 and into the soot layer 144 of the preform 120b and visa versa. Additional glassy barrier layers may be employed as needed. FIGS. 11 and 12 illustrate soot preforms 120a, 120b that are formed on a mandrel (thus forming the centerline aperture upon its removal) in one deposition step, i.e., without any intermediate consolidation step of the first formed segments. Additional silica soot may be deposited on the formed core canes once formed from the soot preforms of FIGS. 11 and 12. The deposition process for the additional silica soot may be the substantially dry process described in U.S. patent application Ser. No. 60/258,132, the specification of which is incorporated herein by reference or by conventional deposition methods.

Barrier layer 135a or 135b may be vitrified by any method able to apply sufficient heat to the surface thereof. For example, one preferred method of vitrifying involves firepolishing with a flame. Preferably, the flame is produced by igniting a substantially hydrogen-free fuel (e.g., carbon monoxide) so that the vitrifying step does not add any appreciable water to the preform.

Another method for vitrifying the layer comprises exposing the surface portion to a laser beam emanating from a laser device. The laser device, such as a CO₂ laser, emits a collumated beam portion having a spot diameter “d” of about 2 mm to 4 mm. The beam portion is passed through a focusing device, such as a lens, thereby providing a focused beam. The focused beam is focused on a surface of the soot preform 120a or 120b, such that it exhibits an exposure point at the surface of diameter “d” of between about 0.5 mm and 2.5 mm. The laser beam has sufficient energy to vitrify the surface and form the vitrified glassy layer 135a or 135b as the preform 120a or 120b is rotated about its axis.

For each rotation, the laser or preform is moved in the axial direction by an incremental amount. In this fashion, the laser beam is traversed along the axial length of the preform 120a or 120b. The two successive positions of a first revolution, respectively, overlap such that the surface is vitrified to the desired depth without any portion of the surface being missed. However, it should be noted that any axial traversal scheme may be employed such that the entire surface becomes vitrified. Preferably, deposition is suspended while the vitrified layer 135a or 135b is being formed. It should be recognized, that although the exemplary embodiments of a laser and firepolishing have been provided, that other means for vitrifying the surface may be utilized as well, such as induction heating, and plasma torch. Any means that may generate sufficient heat may be employed. The invention is not limited to a preform that contains only one or two barrier layers. The preform may include any number of barrier layers as desired.

Another aspect of the invention relates to a method of preferentially doping one region of a soot preform with fluorine and not doping another region of the preform with fluorine, preferably only doping one region of the preform and not doping any other regions of the preform. The perform utilized in this aspect of the invention may be made in accordance with anyone of the above techniques described for manufacturing a soot preform, see the discussion of FIGS. 1 and 2 above. Preferably the preform is substantially devoid of a sintered glass region. Optionally, prior to fluorine doping of the preform, the preform is dried as previously explained.

In accordance with this aspect of the invention, the preform is exposed to a fluorine containing atmosphere in a furnace. An example of an embodiment of this aspect of the invention is illustrated in FIG. 2. The aspect of the invention further includes heating the soot preform in the fluorine containing atmosphere from a first temperature to a doping temperature at a rate of more than 10° C. per minute. Preferably the temperature in the furnace is increased from the first temperature to the doping temperature at a rate of at least about 20° C. per minute, more preferably at least about 25° C. per minute, and most preferably at least about 30° C. per minute. The rate is not required to remain constant. The rate may increase during the heating step.

Preferably the first temperature is the temperature of the soot preform after the optionally drying step is completed, a temperature of about 1000° C. to about 1100° C. In one preferred embodiment of the invention, the first temperature is no more than about 1100° C. The doping temperature comprises a temperature of more than about 1200° C., preferably more than about 1225° C., more preferably more than about 1250° C., and most preferably up to about 1500° C.

Preferably the transition time from the first temperature to the doping temperature is less than about sixty (60) minutes, more preferably no more than about forty-five (45) minutes, and most preferably no more than about thirty (30) minutes.

Once the preform has reached the doping temperature, the preform may be continued to be exposed to the fluorine containing atmosphere for a given period of time. The period of time my last from three (3) minutes to no more than about six (6) hours, preferably no more than about four (4) hours.

Furthermore, the aspect of the invention may include the optional step of sintering the fluorine doped preform. The preform may be sintered as previously explained. Optionally, the preform may be sintering in an atmosphere that contains fluorine. However, the sintering atmosphere is not required to include fluorine. The sintering temperature can be the same as previously explained. A preferred sintering temperature is about 1450° C. In one embodiment of this aspect of the invention, the doping temperature and the sintering temperature can be about 1450° C.

The sintered preform may be drawn into an optical fiber as previously explained or additional soot may be deposited on the preform as explained above in regard to FIG. 6. The soot coated sintered preform may be sintered and drawn into an optical fiber.

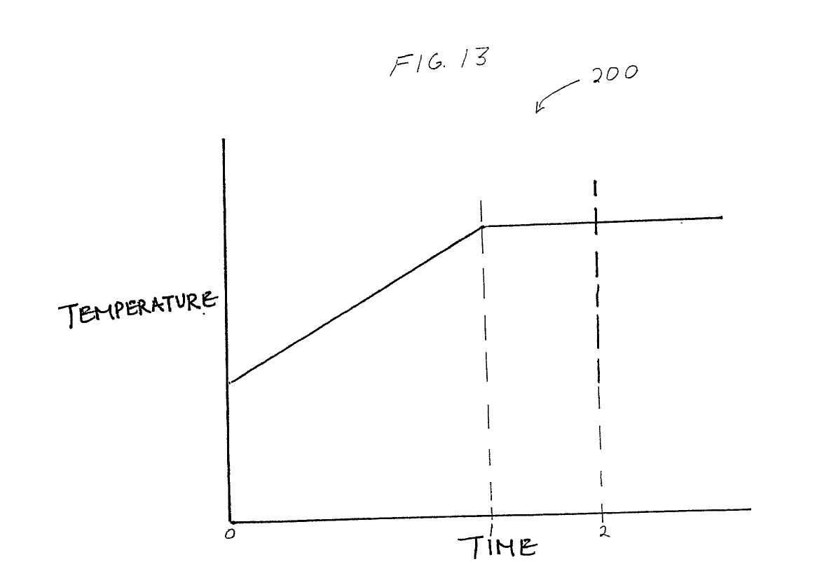

An example of thermal profile of an embodiment of this aspect of the invention is illustrated in FIG. 13. FIG. 13 is a graph of the temperature of the preform as a function of time, generally illustrated as 200. The temperature of the preform is increased from a first temperature at time zero to a doping temperature at time 1 (T₁). The preform is also exposed to a fluorine containing atmosphere from time zero to time 1 (T₁). Once the temperature of the preform has reached the doping temperature, the preform was maintained in the fluorine containing atmosphere until time 2 (T₂). In the illustrated embodiment, the sintering temperature and the doping temperature were the same. At time 2 (T₂), the fluorine containing atmosphere was discharged from the furnace and the preform was sintered.

This aspect of the invention may be used to produce a preform with sharper profiles between a fluorine doped region of the preform and non-fluorine doped regions of the preform. One technique to determine how sharp a profile is to prepare a plot of the weight percent of fluorine as a function of radius of the preform.

The degree of sharpness of a preform is determined by the slope of a segment of the fluorine weight percent plot. The closer to vertical the line, the less migration of fluorine out of the desired region and the sharper the refractive index profile. A sharp preform has a plot having a segment with a slope of more than about 2.3 weight percent of fluorine, preferably at least 2.5 weight percent of fluorine, more preferably about 5.0 weight percent of fluorine, and most preferably at least about 16.0 weight percent of fluorine. Preferably, the segment of the slope which is sharp will be at least 4 μm away a central core of the resultant fiber.

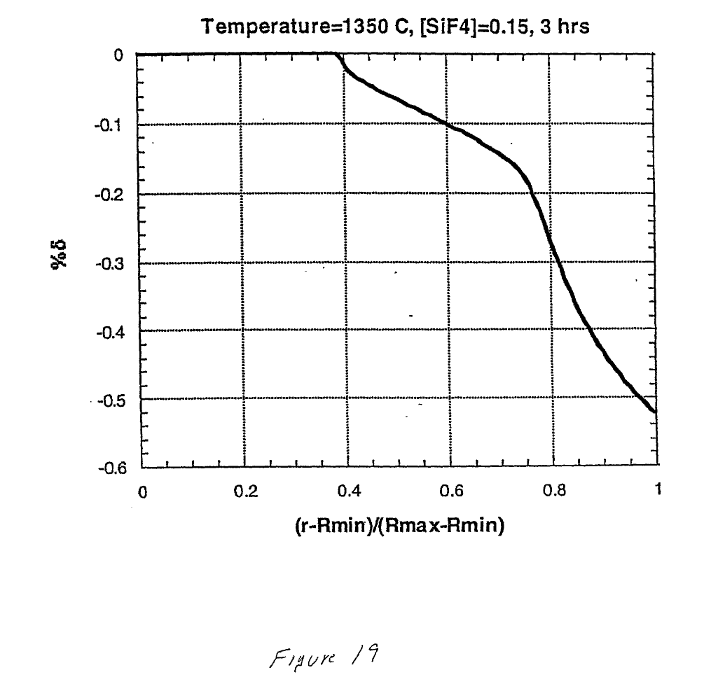

As shown in FIG. 18, the fluorine weight percent starts before a normalized radius of about 0.5. At about a normalized radius, the fluorine weight percent is less than about 0.2 weight percent. At about a normalized radius of about 0.6, the fluorine weight percent is more than about 0.6 weight percent (slope of more than about 4 weight percent). The fluorine weight percent continues to increase until about a normalized radius of about 0.8, where the fluorine weight percent is more than about 1.64 (slope of more than about 8).

A further aspect of the invention relates to another method of preferentially doping one region of a soot preform with fluorine and not doping another region of the preform with fluorine, preferably only doping one region of the preform and not doping any other regions of the preform. The perform utilized in this aspect of the invention may be made in accordance with anyone of the above techniques described for manufacturing a soot preform, see the discussion of FIGS. 1 and 2 above. Preferably the preform is substantially devoid of a sintered glass region. Also, after deposition, the preform may have a constant density or a dual density. Dual density is used herein to mean a preform that has at least two different axial regions which do not have the same density. Optionally, prior to fluorine doping of the preform, the preform is dried as previously explained.

Preferably, the method includes a first heating step of heating at least a portion of the soot preform to a first temperature of at least about 1300° C., preferably more than about 1300° C., more preferably at least about 1350° C., and most preferably at least about 1400° C. The heating of the preform can take place in any device that can be used to raise the temperature of a soot preform, e.g. a furnace. Preferably, the temperature of the soot preform is heated to the first temperature at a fast rate, such as at rate of about at least about 10° C. per minute, more preferably a rate of at least about 20° C. per minute, most preferably a rate of at least about 30° C. per minute. It is preferred to minimize the amount of time that it takes to heat the soot preform to the first temperature.

During the first heating step, it is not required that the preform reaches an isothermal temperature. The preform may exhibit a radial temperature gradient. Preferably, the temperature gradient is an axial gradient and the temperature increases as the radial distance from the center of the preform increases. Thus, this aspect of the invention can include an embodiment in which the temperature of the outer surface of the perform is higher than the temperature of an internal region of the preform at the end of the first heating step. However, this aspect of the invention is not limited to the aforementioned embodiment.

Preferably, the method also includes cooling at least a portion of the soot preform to a cooling temperature. The portion of the soot preform which was cooled may be the same portion of the soot preform heated to the first temperature during the first heating step or a different portion of the soot preform. Preferably, the cooling temperature is above 1100° C., more preferably at least about 1200° C., most preferably at temperature of less than about 1300° C. It is also preferred that the cooling temperature is less than the first temperature.

It is also preferred that the time period from the beginning of the cooling step to the end of the cooling step is a short time period. The time period to complete the cooling step should be less than about sixty (60) minutes, preferably no more than about twenty (20) minutes, more preferably no more than about fifteen (15) minutes, and most preferably no more than about ten (10) minutes.

Preferably, the soot preform is cooled such that the preform will exhibit a radial temperature gradient. Preferably, the temperature on the outer regions of the preform is less than the temperature of the inner regions of the preform. In a preferred embodiment of the cooling step of this aspect of the invention, an outer region of the preform is cooled to the cooling temperature and an inner region of the preform is maintained at a temperature higher than the cooling temperature.

The method further includes a second heating step of heating the soot preform in a fluorine containing atmosphere to a second temperature. Preferably, the second heating step comprises increasing the temperature in the furnace from the cooling temperature to the second temperature at a rate of more than about 10° C. per minute. Preferably, the rate is at least about 20° C. per minute, more preferably, at least about 25° C. per minute, and most preferably at least about 30° C. per minute.

In one embodiment of this aspect of the invention the second temperature may be the same as the sintering temperature. In the embodiment, during the second heating step, preferably at least one portion of the preform is heated to a sintering temperature, more preferably more than half of the preform, in the axial direction, is heated to the sintering temperature, and most preferably, substantially all of the preform is heated to the sintering temperature.

In another embodiment of this aspect of the invention, the second temperature is not the same as the sintering temperature. Preferably, the second temperature is less than the sintering temperature. The embodiment of this aspect of the invention may include the additional step of heating the preform from the second temperature to a sintering temperature. A suitable fluorine containing atmosphere is the same as previously described.

Optionally, the soot preform may be sintered in the fluorine containing atmosphere or in a non-fluorine containing atmosphere. The sintering atmosphere may also include an inert material as previously disclosed in above disclosures regarding the atmosphere in a furnace during sintering. The sintering temperature is typically a temperature of at least about 1400° C., preferably at least about 1450° C.

The sintered preform may be drawn into an optical fiber as previously explained or drawn into a cane and additional soot may be deposited on the preform as explained above in regard to FIG. 6. The soot coated sintered preform may be sintered and drawn into an optical fiber.

Optionally, the method may include the step of maintaining the preform at the first temperature. Preferably, the perform is maintained at the first temperature for a sufficient period of time so that the preform reaches an isothermal temperature. Isothermal temperature is used herein in the same manner as defined above. Preferably, the isothermal temperature is more than about 1225° C. Preferably, the period of time is no more than about forty-five (45) minutes, more preferably, no more than about thirty (30) minutes, most preferably no more than about fifteen (15) minutes.

In a preferred embodiment of the invention, the preform is heated to the first temperature after the aforementioned drying of the preform. Preferably, the temperature of the preform at the end of drying is no more than about 1200° C., more preferably, no more than about 1100° C.

Optionally, the method may include repeating the first heating step and the cooling step at least once. Preferably, the first heating step and the cooling step are repeated before exposing of the soot preform to a fluorine containing atmosphere.

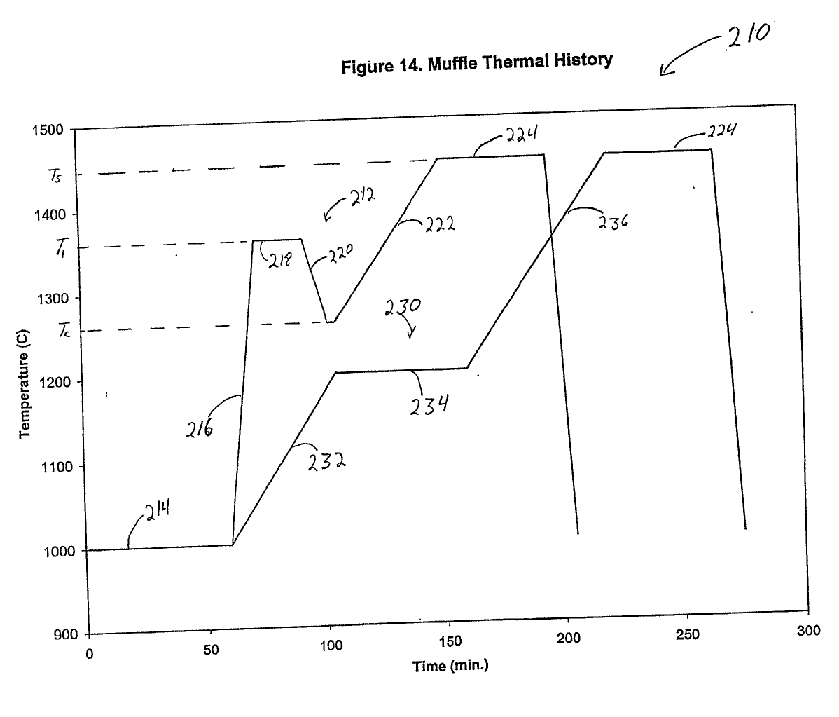

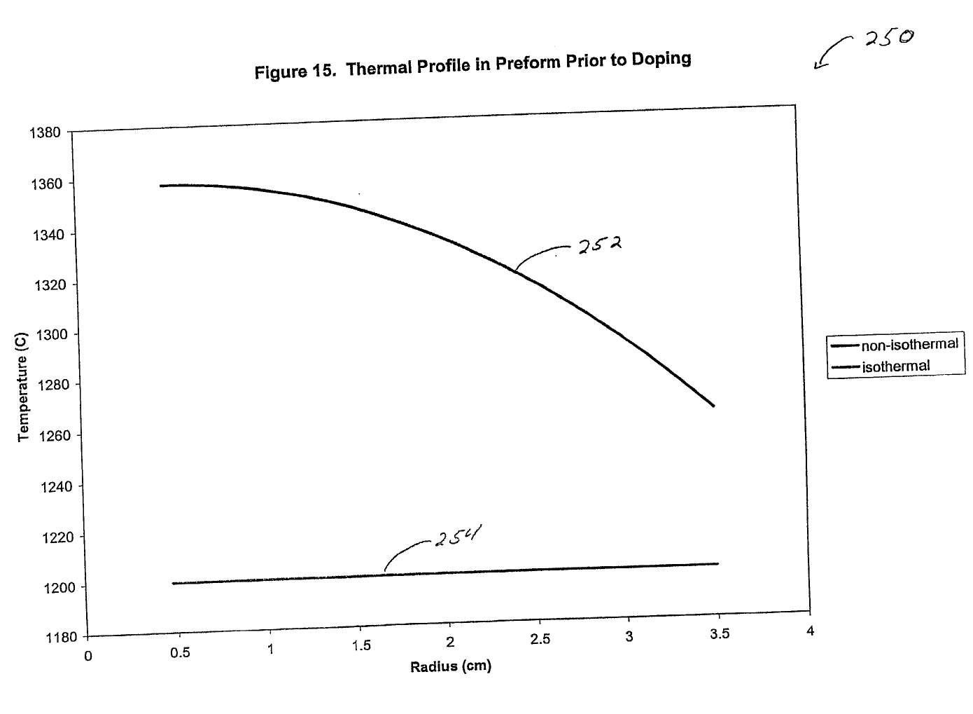

Illustrated in FIG. 14, generally designated 210, is the thermal history of a muffle for this aspect of the invention as well as a known technique for making a sintered preform having a fluorine doped region. FIG. 14 is a graph of the temperature within the muffle as a function of time. The inventive method of this aspect of the invention is generally designated as 212. The depicted embodiment of the inventive method begins with a drying step 214. During the drying step, the temperature in the muffle is about 1000° C. for more than about fifty (50) minutes. The drying step proceeds as previously disclosed herein. After the drying step, the temperature in the muffle is quickly increased to the first temperature (T₁), represented as 216. The temperature in the muffle is maintained at T₁ for a short period of time. The temperature in the muffle is then lowered to a cooling temperature (T_{c}), represented as 220.

Once the temperature in the muffle has reached T_{c}, the preform in the muffle is exposed to a fluorine containing atmosphere, 222. The temperature in the muffle during the fluorine exposure is increased to a second temperature (Tₛ) at a rate of more than 10° C. per minute. The muffle temperature reaching the temperature Tₛ is represented by 224. Once the temperature in the muffle has reached Tₛ, the atmosphere in the muffle may continue to include fluorine for a predetermined time as previously disclosed. In this embodiment of the invention, Tₛ is the same as the sintering temperature. Optionally at some point along segment 224, the fluorine containing atmosphere may be discharged from the muffle and the perform may continue to be sintered. It should be noted in this embodiment, the doping temperature is the same as Tₛ. In a second embodiment, Tₛ may differ from the sintering temperature, preferably the second temperature would be a temperature higher than T_{c} and lower than the sintering temperature.

In the known technique generally designated 230, the soot preform is also dried at a temperature of 1000° C., 214. Next, the temperature in the muffle is increased to a doping temperature at a rate of two (2) to less than ten (10)° C. per minute to the doping temperature, 232. The preform in 230, is doped at a constant temperature, 234. Finally, the temperature is increased to a sintering temperature, 236, and the preform is sintered at the sintering temperature, 224.

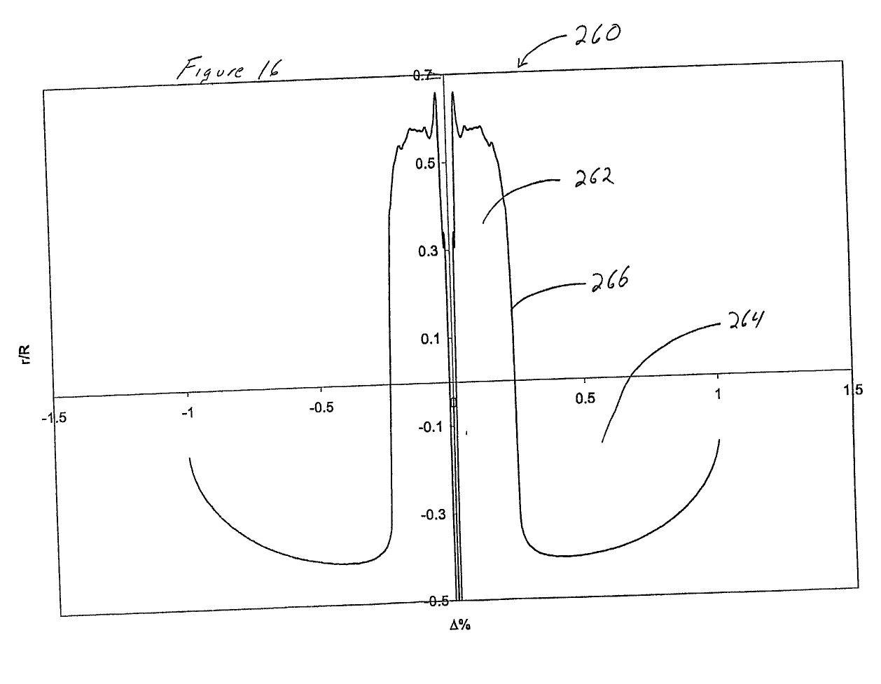

Illustrated in FIG. 15 is the thermal profile of the soot blanks of FIG. 14 prior to fluorine doping of the respective preforms, generally designated as 250. FIG. 15 is a graph of the temperature of the preform as a function of the radius of the preform at a time period immediately prior to exposing the preform to a fluorine containing atmosphere. The profile of the soot preform heated in accordance with method designated as 212 is represented by line 252. The temperature of the preform is at its highest value at a location closest to the center of the preform and decreases as the radial distance from the center of the preform increases. In comparison, the profile of the soot preform heated in accordance with method designated as 230 is represented by line 254.

An advantage of the invention, is that the methods disclosed may be used to produce the core section of an optical fiber having at least one fluorine doped region that was sintered only one time prior to the deposition of soot for a cladding section of the fiber. A fiber made with a core that is formed by a single consolidation step has the advantage of not containing physical interfaces, such as barrier layers, which cause scattering losses. Another advantage of this aspect of the invention is that the aspect may be practiced to produce a preform with a sharp refractive index profile. Sharp is used herein as previously defined. Furthermore, the aforementioned methods are useful in the manufacturing of an optical fiber having a segmented core profile. Segmented core profile is used herein to mean at least an optical fiber that has a core that includes two or more regions. Preferably, the refractive index of at least one point of each region is different than the refractive index of each point of at least one other region and vice versa.

### EXAMPLES

The invention will be further clarified by the following examples which are intended to be exemplary of the invention.

In Examples 1 and 2, silica soot preforms were fluorine doped in accordance with the following process. The OVD process was used to form the preforms. The starting member was a ⅜″ alumina bait rod. The resulting preforms were pure silica soot about 1 m long and about 7 cm in diameter. The density of each preform ranged from about 0.397 to about 0.531 g/cm³ and the weight of each preform was approximately 1714 g.

### Example 1

Each preform was dried in a chlorine containing atmosphere at a temperature of about 950° C. for a period of about sixty (60) minutes. The temperature of each preform was linearly increased to a first temperature of about 1285° C. and the temperature of the preform was maintained at about 1285° C. for about forty-five (45) minutes. The preform was isothermally fluorine doped in an atmosphere comprising CF₄ for about thirty (30) or about ninety (90) minutes at a temperature of 1285° C. Thus, in example 1 the heat treating temperature (first temperature) and the doping temperature (second temperature) were about the same. The concentration of CF₄ in the doping atmosphere was either about 6.6% or about 11.5% by volume

After fluorine doping, the preforms were heated to a temperature of 1350° C. and maintained at that temperature for about forty-five (45) minutes and then the preform was heated to a sintering temperature of about 1450° C. and maintained at the sintering temperature for about forty-five (45) minutes. Each temperature transition was a linear progression and took about forty-five (45) minutes.

The preforms were drawn into 8 mm canes and the refractive index profile of each cane was determined using a P106 York (available from GN Nettest of Utica, N.Y. or PK Technology Instruments of Beaverton, Oreg.).

The results of the experiment are shown in FIG. 7. FIG. 7 is a graph of the concentration of fluorine in the cane in terms of Δ% as a function of a normalized radius. The concentration of fluorine in the cane was greater in regions of the cane having a radius of at least about 0.4.

### Example 2

The procedure to manufacture the test preform in example 2 was the same as the procedure disclosed in example 1 except that both the heat treating temperature and doping temperature in example 2 was 1320° C. instead of 1285° C. and the preform was exposed to a fluorine doping atmosphere, containing 11.5% CF₄ by volume for about ninety (90) minutes.

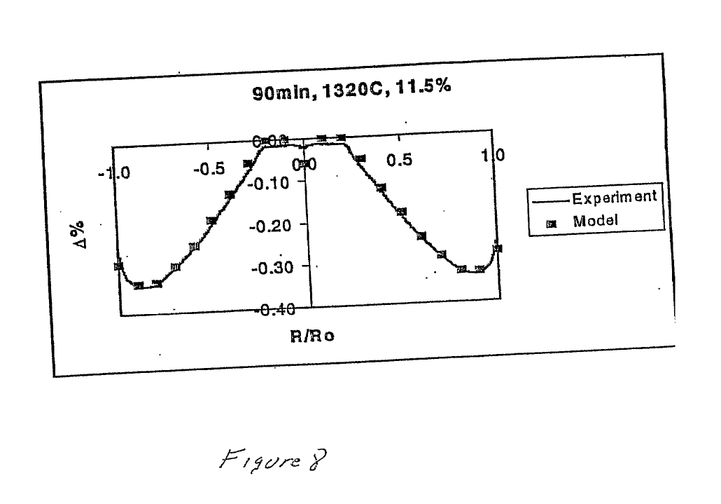

The results of the experiment are shown in FIG. 8. FIG. 8 is a graph of the concentration of fluorine (y-axis) in the cane in terms of Δ% as a function of a normalized radius (x-axis). The concentration of fluorine in the cane was greater in regions of the cane having a radius of at least about 0.5 or more. The Δ% of fluorine was less than about −0.30%. The Δ% realized change was about −0.32%. The Δ% was achieved without the use of a barrier layer or another type of physical interface.

### Example 3

In this example, the effect of increasing the temperature of a preform having a region of fluorine doped silica soot to a sintering temperature at a fast rate (preferably a rate of more than about 10° C./min) was tested. Two soot preforms were formed from identical deposition processes. Each preform had an outer region of deposited fluorine doped silica soot with a fluorine content of about 1.1% to about 1.2% of fluorine. The outer region of fluorine doped soot started at about 2000 μm from the center of the core and extended to the outer edge of the preform.

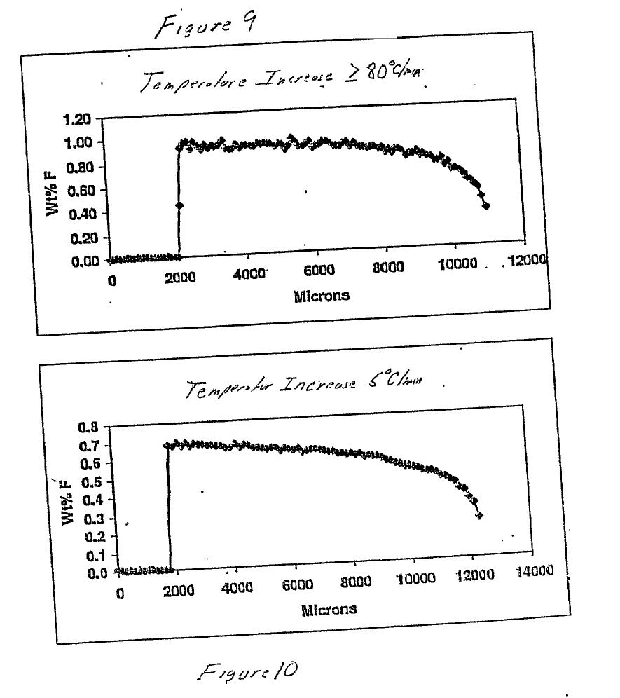

The control preform was maintained at a temperature of about 1000° C. for about forty-five (45) minutes. The control preform was then heated from about 1000° C. to about 1450° C. at a rate of about 5° C./min. The test preform was maintained at a temperature of about 1000° C. for about forty-five (45) minutes. The test preform was then heated from about 1000° C. to about 1400° C. in a period of less than about 5 (five) minutes. A microprobe was used to determine the fluorine concentration along the radial direction of each preform. The results of the experiment are shown in FIGS. 9 and 10. The fluorine concentration of the preform is plotted along the y-axis as a function of the radius of the preform. As shown in FIGS. 9 and 10, the test preform retained more of the fluorine than the control preform.

### Example 4

In this example an optical fiber cane having a sharp refractive index profile is formed. A soot preform having a germanium doped core region and the undoped region outer region was formed. The preform was dried for sixty (60) minutes at a temperature of about 1000° C. A drying atmosphere was flown down both the centerline of the preform as well as the exterior of the muffle. The center line drying atmosphere comprised of chlorine and helium in a ratio of 1:6. The exterior drying gas also comprised chlorine to helium in a ratio of 1:50.

After drying, the temperature of the preform was increased to about 1275° C., at a rate of about 11° C. per minute. The preform was held at 1275° C. for a period of at least about 6 minutes. The preform was doped in an atmosphere of CF₄ and He at a doping temperature of about 1275° C. for a period of about sixty (60) minutes. The ratio of CF₄ to He was about 1:3.

After doping, the temperature was increased to a sintering temperature of about 1450° C., the time period to increase the temperature to the sintering temperature comprised about sixty (60) minutes. The perform was sintered at the sintering temperature for about forty-five (45) minutes.

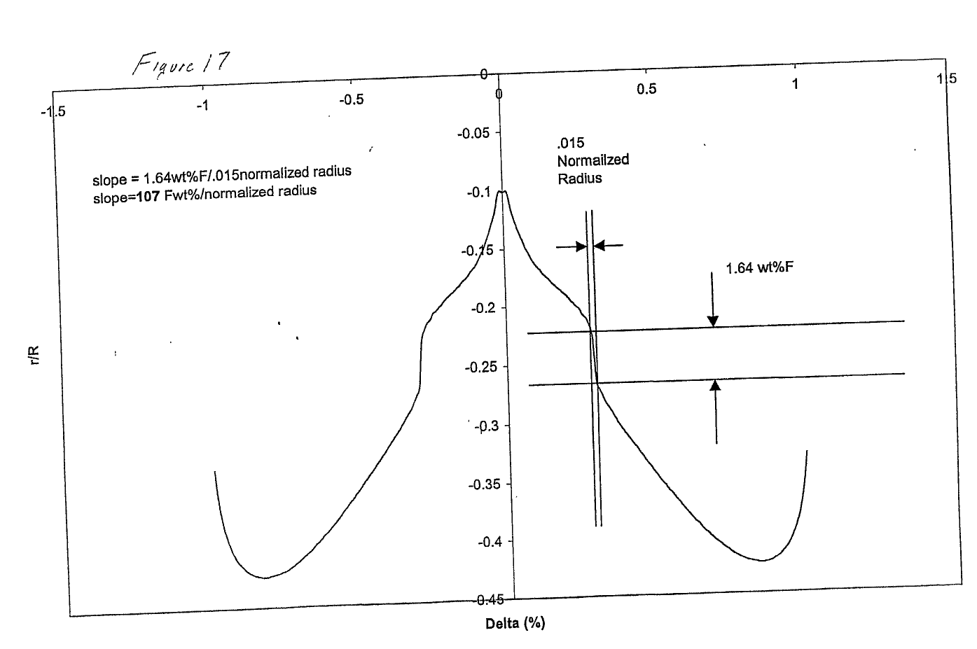

As illustrated in FIG. 16, a cross section of the refractive index of the was exhibited by the use of a York apparatus as previously described. The refractive index profile depicted in FIG. 16, generally designated by reference numeral 260, is in terms of delta percent as a function of a normalized radius. The cane has a germanium doped region, designated by reference numeral 262, and a fluorine doped region generally designated by reference numeral 264. The refractive index exhibited by the cane is represented by line 266. Line 266 exhibits at least one segment having a slope with an absolute value of greater than about 2.5 wt % of F. One example of such a segment would begin at a delta percent value of less than about 0.5% and extend to a delta percent value of more than about −0.3%. As a person of ordinary skill in the art will observe at about 0.25 radial units, line 262 includes at least one segment that is about perpendicular to the x-axis of FIG. 16.

### Example 5

In this example an optical fiber with a silica core region and a fluorine doped cladding, having a sharp refractive index profile, is formed. The preform was formed by depositing silica soot on a starting member. The silica was undoped. The preform was dried for sixty (60) minutes at a temperature of about 1000° C. in a furnace. A drying atmosphere was flown down both the centerline of the preform as well as the exterior of the muffle. The center line drying atmosphere comprised of chlorine and helium in a ratio of 1:6. The exterior drying gas also comprised chlorine to helium in a ratio of 1:50.

After drying, the temperature in the furnace was increased to a temperature of about 1350° C. in a time period of about eight (8) minutes. The temperature in the furnace was maintained at about 1350° C. for a period of about twenty-four (24) minutes. Then the temperature in the furnace was lowered to about 1246° C. The time period to lower the temperature from 1350° C. to about 1246° was about thirteen (13) minutes.

After cooling, at least one region of the preform was doped with fluorine. The preform was doped with fluorine in an atmosphere of CF₄ and He for a period of about sixty (60) minutes. The ratio of CF₄ to He was about 1:3. During the doping step, the temperature in the furnace was increased from about 1246° C. to about 1460° C. The temperature was increased at a rate of about three (3) to four (4)° C. per minute. After doping, the temperature in the furnace was maintained at about 1450° C. for about forty-five (45) minutes. Subsequently, the preform was drawn into an optical fiber.

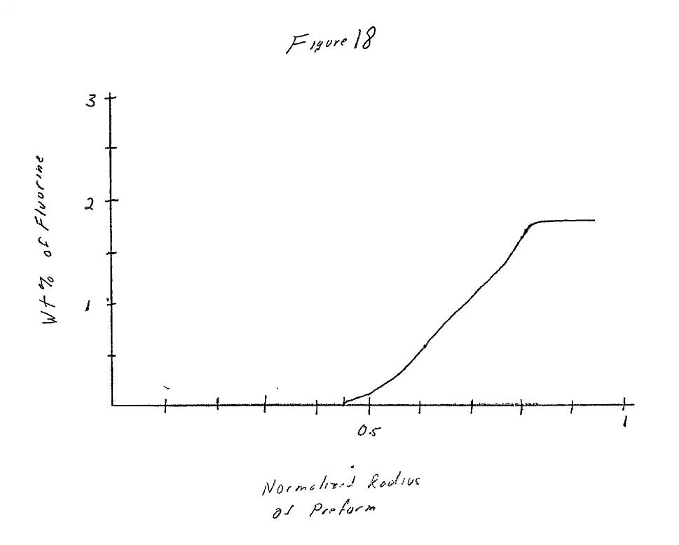

Depicted in FIG. 17 is the refractive index profile of the of the drawn fiber. The profile is in terms of delta percent as a function of a normalized radius. As shown in FIG. 17, the refractive index profile exhibits at least one segment at which the profile has a sharp profile. At the intersection of the cross-hairs, a plot of the weight % of F versus radius would have a slope with an absolute value of about 107. The change in normalized radius represents a radial increase of about 0.015 units. The increase in fluorine doping over the same area of the profile represents an increase in the concentration of fluorine of about 1.64 weight percent in the examined region of the preform in relation to the region of the preform immediately radially smaller than the region in the cross-hairs.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method of making an optical fiber containing a fluorine doped region comprising:
heat treating a porous soot preform, the preform substantially devoid of any sintered glass layer, to a temperature of greater than about 1200° C.; and
exposing the preform to an atmosphere comprising a fluorine containing compound, wherein the time and the temperature of said exposing step is controlled so that Φ comprises≧about 1 wherein Φ is defined as Rₘₐₓ/(D/k)^{½}, wherein Rₘₐₓ is the outer radius of the preform, D is the diffusion coefficient of the fluorine containing compound into the preform, and k is the reaction rate constant of the reaction between the fluorine and the soot, thereby controlling the radial penetration of fluorine into the preform.

2. The method according to claim 1 wherein said heat treating step further comprises an atmosphere substantially devoid of any halide containing compound.

3. The method according to claim 1 wherein said Φ comprises≧about 2.

4. The method according to claim 1 wherein the soot preform is substantially devoid of a physical interface.

5. The method according to claim 1 wherein the pressure during said exposing comprises about atmospheric pressure.

6. The method according to claim 1 wherein said heat treating step results in an average reduction in pore size of at least about 25%.

7. The method according to claim 1 wherein said exposing step occurs at a temperature different than the temperature of said heat treating step.

8. The method according to claim 1 wherein the porous soot preform comprises at least two regions, a germanium doped first region when sintered having a Δ₁ and a second region when sintered having a Δ₂ which surrounds the first region, wherein Δ₁ is ≧Δ₂.

9. The method according to claim 1 wherein a time period for said heat treating comprises at least about 30 minutes.

10. The method according to claim 1 wherein said exposing occurs at a temperature that comprises at least about 1225° C.

11. The method according to claim 1 wherein a density of the porous soot preform comprises about 0.2 to about 1.2 g/cm.

12. The method according to claim 1 further comprising sintering the soot preform and drawing the sintered preform into a cane.

13. The method according to claim 1 wherein the soot preform is formed by depositing a first region of silica soot doped with a refractive index increasing dopant and a second region of undoped silica soot on a starting member.

14. A method of making an optical fiber containing a fluorine doped region comprising:
heat treating a porous soot preform, the preform substantially devoid of any sintered glass layer, to a temperature of at least about 1250° C.; and
doping the soot blank with fluorine at a doping temperature of at least about 1300° C. such that a radial gradient of fluorine doping across the soot blank is great enough to result in a fiber having a change in delta, across a radial fluorine doped region, that is less than about −0.25% with respect to the cladding, where Δₐ₋=(nₐ²−n_{b}²)/(2nₐ²), nₐ being the refractive index of the fluorine-doped glass and n_{b} being the refractive index of the cladding.

15. The method according to claim 14 wherein the doping temperature comprises at least about 1320° C.

16. The method according to claim 14 wherein a thickness of the fluorine doped region comprises less than about 80% of the radius for the entire preform.

17. A method of making an optical fiber containing a fluorine doped region comprising:
depositing fluorine doped silica soot on a starting member to form a soot preform having at least one fluorine doped soot region; and
heating the soot preform at a rate of more than about 10° C./min to a temperature of more than about 1300° C.

18. The method according to claim 17 wherein the temperature of said heating step comprises at least about 1350° C.

19. The method according to claim 17 wherein the rate comprises at least about 20° C./min.

20. The method according to claim 17 further comprising depositing at least one doped soot region on the starting member wherein the dopant is one selected from the group consisting of Ge, Sb, P, Bi, Li, Na, K, Rb, Cs, Fr, Be, Mg, Ca, Sr, Ba, Ra, and mixtures thereof.

21. The method according to claim 17 wherein an atmosphere of said heating step comprises at least one inert gas.

22. A method of making an optical fiber containing a fluorine doped region comprising:
heating a preform having at least one region of fluorine doped soot at a rate of more than about 10° C./min to a temperature of more than about 1400° C.

23. The method according to claim 22 wherein the temperature comprises more than about 1450° C.

24. The method according to claim 22 wherein an atmosphere of said heat treating comprises an atmosphere substantially devoid of any reactive material.

25. The method according to claim 22 wherein said heat treating comprises sintering the preform.

26. The method according to claim 22 further comprising depositing at least one doped soot region on a starting member wherein the dopant is one selected from the group consisting of Ge, Sb, P, Bi, Li, Na, K, Rb, Cs, Fr, Be, Mg, Ca, Sr, Ba, Ra, and mixtures thereof.

27. A method of making an optical fiber containing a fluorine doped region comprising:
heat treating a porous soot preform, the preform substantially devoid of any sintered glass layer to a first temperature; and
exposing the preform to an atmosphere comprising a fluorine containing compound at a second temperature, wherein the rate of reaction between the fluorine and the soot and the rate of diffusion of the fluorine compound into the preform are both temperature dependent and an increase in the rate of reaction as a function of increasing temperature comprises more than an increase in rate of diffusion as a function of increasing temperature, thereby controlling the radial penetration of fluorine into the preform.

28. The method according to claim 27 wherein the soot preform is substantially devoid of a physical interface.

29. The method according to claim 27 wherein the pressure during said exposing step comprises about atmospheric pressure.

30. The method according to claim 27 wherein said heat treating step results in an average reduction in pore size of at least about 25% of the pores of the porous preform.

31. The method according to claim 27 wherein the first temperature and the second temperature are different.

32. The method according to claim 27 wherein the first temperature and the second temperature are about the same.

33. The method according to claim 27 wherein the first temperature comprises a temperature of at least above about 1200° C. and said heat treating takes place for a time period of at least about 30 minutes.

34. The method according to claim 33 wherein said second temperature comprises at least about 1225° C.

35. The method according to claim 27 wherein the soot preform is formed by depositing a first region of silica soot doped with a refractive index increasing dopant and a second region of undoped silica soot on a starting member.

36. A method of making an optical fiber containing a fluorine doped region comprising:
depositing at least one region of fluorinated doped soot on a starting member forming a porous soot preform;
heat treating the porous soot preform to a temperature of greater than about 1200° C. for a period of at least about twenty minutes, wherein the time and the temperature of said heat treating step is controlled so that Φ comprises≧about 1 wherein Φ is defined as Rₘₐₓ/(D/k)^{½} wherein Rₘₐₓ is the outer radius of the preform, D is the diffusion coefficient of the fluorine containing compound into the preform, and k is the reaction rate constant of the reaction between the fluorine and the soot, thereby controlling the radial penetration of fluorine into the preform.

37. The method according to claim 36 wherein said Φ comprises≧about 2.

38. The method according to claim 36 wherein said Φ comprises≧about 10.

39. The method according to claim 36 wherein the soot preform comprises a barrier layer.

40. The method according to claim 36 further comprising drying the soot preform with a drying gas that includes a chlorine containing compound including at least one silicon or germanium element.

41. The method according to claim 36 further comprising forming a barrier layer in the soot preform.

42. The method according to claim 36 further comprising depositing at least one region of silica soot doped with a refractive index increasing dopant and at least one region of undoped silica soot on the starting member, whereby the at least one region of undoped silica soot located between the at least one region of silica soot doped with the refractive index increasing dopant and the at least one region of fluorine doped silica soot.

43. The method according to claim 36 wherein said heat treating temperature comprises at least about 1225° C.

44. The method according to claim 36 wherein the soot preform comprises more than about 1 barrier layer.

45. The method according to claim 36 wherein said heat treating includes sintering the porous soot preform.

46. The method according to claim 36 further comprising sintering the perform.

47. The method according to claim 36 further comprising drawing the soot preform into a cane and depositing soot onto an outer surface of the cane.

48. A method of making an optical fiber containing at least one fluorine doped region comprising:
exposing a preform having at least one region of soot to a fluorine containing atmosphere in a furnace; and
heating the soot preform in the fluorine containing atmosphere from a first temperature to a doping temperature at a rate of more than 10° C. per minute.

49. The method of claim 48 wherein the rate comprises at least about 20° C. per minute.

50. The method of claim 48 wherein the rate comprises at least about 25° C. per minute.

51. The method of claim 48 wherein a transition time period from the first temperature to the doping temperature comprises no more than about 30 minutes.

52. The method of claim 48 wherein the doping temperature comprises more than about 1225° C.

53. The method of claim 48 wherein the doping temperature comprises at least about 1250° C.

54. The method of claim 48 wherein the first temperature comprises no more than about 1100° C.

55. The method of claim 48 wherein the doping temperature comprises a temperature up to about 1450° C. and further comprising discharging the fluorine atmosphere from the furnace and maintaining the temperature at about 1450° C.

56. A method of making an optical fiber containing at least one fluorine doped region comprising:
exposing a preform, having at least one region of soot, to a fluorine containing atmosphere in a furnace; and
heating the soot preform in the fluorine containing atmosphere from a starting temperature to a doping temperature at a rate at least about 20° C. per minute.

57. The method of claim 56 wherein the rate comprises at least about 25° C. per minute.

58. The method of claim 56 wherein a transition time period from the first temperature to the doping temperature comprises no more than about 30 minutes.

59. The method of claim 56 wherein the doping temperature comprises more than about 1225° C.

60. The method of claim 56 wherein the doping temperature comprises at least about 1250° C.

61. The method of claim 56 wherein the first temperature comprises no more than about 1100° C.

62. The method of claim 56 wherein the doping temperature comprises a temperature up to about 1450° C. and further comprising discharging the fluorine atmosphere from the furnace and maintaining the temperature at about 1450° C.

63. A method of making an optical fiber containing at least one fluorine doped region comprising:
heat treating a porous soot preform, the preform substantially devoid of any sintered glass layer, from a first temperature to a second temperature, increasing the temperature from said first temperature to said second temperature at a rate of more than about 10° C. per minute; and
doping at least one region of the preform with fluorine at a doping temperature of greater than about 1225° C.

64. The method according to claim 63 further comprising forming the porous soot preform by depositing at least one region of silica soot doped with germanium on a starting member and depositing at least one region of undoped silica soot on a starting member.

65. The method according to claim 63 wherein the second temperature and the doping temperature comprises the same numerical value.

66. The method according to claim 63 wherein said second temperature comprises a temperature of more than about 1225° C.

67. The method according to claim 64 further comprising sintering the preform and drawing the preform into a cane, wherein a plot of fluorine concentration of a cross section of the cane, in terms of fluorine weight percent and a normalized radius, exhibits at least one segment between the germanium doped region of the cane and the fluorine doped region of the cane having a slope with an absolute value of more than about 2.5 wt % F.

68. The method according to claim 67 wherein said slope comprises at least about 5.

69. The method according to claim 67 wherein said slope comprises at least about 16.

70. The method according to claim 63 wherein the second temperature and the doping temperature each comprise a temperature of more than about 1250° C.

71. The method according to claim 64 further comprising sintering the preform and drawing the preform into a fiber, wherein a plot of fluorine concentration of a cross section of the fiber, in terms of fluorine weight percent and a normalized radius, exhibits at least one segment between the germanium doped region of the fiber and the fluorine doped region of the fiber having a slope with an absolute value of more than about 2.5 wt % F.

72. The method according to claim 71 wherein said slope comprises at least about 5.

73. The method according to claim 71 wherein said slope comprises at least about 16.

74. A method of making an optical fiber containing at least one fluorine doped region comprising:
a first heating step of heating at least one region of a soot preform to a first temperature of more than about 1300° C. in a furnace;
cooling the at least one region of the soot preform to a cooling temperature above 1100° C., wherein the cooling temperature comprises a temperature lower than the first temperature;
exposing the soot preform to a fluorine containing atmosphere; and
a second heating step of heating the soot preform in the fluorine containing atmosphere to a second temperature, said second temperature comprises a temperature higher than said cooling temperature.

75. The method according to claim 74 further comprising maintaining the temperature in the furnace at the first temperature for a sufficient period of time for the soot preform to reach an isothermal temperature of more than about 1225° C.

76. The method according to claim 75 wherein said time period comprises no more than about 30 minutes.

77. The method according to claim 75 wherein the isothermal temperature comprises the first temperature.

78. The method according to claim 74 wherein a rate of heating the preform from the cooling temperature to the second temperature comprises at least about 20° C. per minute.

79. The method according to claim 78 wherein the rate comprises at least about 25° C. per minute.

80. The method according to claim 74 wherein said first heating step comprises increasing the temperature to the first temperature at a rate of at least about 20° C. per minute.

81. The method according to claim 74 wherein said first heating step comprises increasing the temperature to the first temperature at a rate of at least about 30° C. per minute.

82. The method according to claim 74 wherein said cooling temperature comprises at least about 1200° C.

83. The method according to claim 74 wherein said cooling temperature comprises less than about 1300° C.

84. The method according to claim 74 further comprising sintering the soot preform in the fluorine containing atmosphere.

85. The method according to claim 74 further comprising drying the soot preform at a temperature of no more than about 1100° C. prior to said first heating step.

86. A method of making an optical fiber containing at least one fluorine doped region comprising:
a) a first heating step of heating at least one region of a soot preform to a first temperature in a furnace;
b) cooling the at least one region of the soot preform to a cooling temperature, in an atmosphere substantially devoid of chlorine, the cooling temperature comprises a temperature of less than the first temperature;
c) exposing the soot preform to a fluorine containing atmosphere; and
d) a second heating step of heating the soot preform in the fluorine containing atmosphere to a second temperature, said second temperature comprises a temperature higher than cooling temperature.

87. The method according to claim 86 further comprising maintaining the temperature in the furnace at the first temperature for a sufficient period of time for the soot preform to reach an isothermal temperature.

88. The method according to claim 86 further comprising sintering the soot preform in the fluorine containing atmosphere.

89. The method according to claim 86 wherein the first temperature comprises at least about 1300° C.

90. The method according to claim 86 wherein the cooling temperature comprises more than 1100° C.

91. The method according to claim 86 further comprising repeating steps a and b at least once prior to said exposing step.

92. A method of making an optical fiber containing at least one fluorine doped region comprising:
a first heating step of heating at least one region of a soot preform to a first temperature of more than about 1300° C. in a furnace;
maintaining the soot preform at a first temperature for a period of time sufficient for the soot preform to reach an isothermal temperature;
cooling the soot preform for a time period of less than about 60 minutes, such that a temperature of the at least one region of the soot preform comprises a cooling temperature, wherein the cooling temperature comprises a temperature of less than the first temperature;
exposing the soot preform to a fluorine containing atmosphere; and
a second heating step of heating the soot preform in the fluorine containing atmosphere to a second temperature, said second heating step comprises increasing the temperature in the furnace from the cooling temperature to the second temperature at a rate of more than about 20° C. per minute.

93. The method according to claim 92 wherein said cooling temperature comprises about 1200° C. or more.

94. The method according to claim 92 wherein the rate comprises at least about 30° C. per minute.

95. The method according to claim 74 further comprising sintering the preform and drawing the preform into a cane having a central core region of undoped silica soot and a fluorine doped region, wherein a plot of fluorine weight percent of a cross section of the cane, in terms of wt % of Fluorine and a normalized radius, exhibits at least one segment between the central core region of the cane and the fluorine doped region of the cane having a slope with an absolute value of more than about 2.5 wt %.

96. The method according to claim 95 wherein the slope comprises more than about 5.0

97. The method according to claim 95 wherein the slope comprises more than about 16.0.

98. The method according to claim 86 further comprising sintering the preform and drawing the preform into a cane having a central core region of undoped silica soot and a fluorine doped region, wherein a refractive index profile of a cross section of the cane, in terms of delta percent and a normalized radius, exhibits at least one segment between the central core region of the cane and the fluorine doped region of the cane having a slope with an absolute value of more than about 2.5%.

99. The method according to claim 98 wherein the slope comprises more than about 5.0

100. The method according to claim 98 wherein the slope comprises more than about 16.0

101. The method according to claim 74 further comprising repeating said first heating step and said cooling step.
